(19) United States
(12) Patent Application Publication
(10) Pub. No.: US 2026/0331565 A1
(43) Pub. Date: Oct. 22, 2026

(54) MAKING SOLID ELECTROLYTE FOR ALL SOLID STATE BATTERIES BY WET BALL-MILLING

(71) Applicants: LG Energy Solution, Ltd., Seoul (KR); The Regents of the University of California, Oakland, CA (US)

(72) Inventors: Jeong Woo Oh, San Diego, CA (US); Min Sang Song, Daejeon (KR); Ke Zhou, San Diego, CA (US); Mengchen Liu, San Diego, CA (US); Ping Liu, San Diego, CA (US)

(21) Appl. No.: 19/181,155

(22) Filed: Apr. 16, 2025

(51) Int. Cl. H01M 10/0562; H01M 10/052

(52) U.S. Cl. CPC H01M 10/0562; H01M 10/052; H01M 2300/008

(57) ABSTRACT

A method of preparing a solid electrolyte (SE) material is disclosed. SE material particles, a solvent, and milling balls are provided such that the SE material particles and the milling balls are completely submerged in the solvent. The SE particles comprise a sulfide-containing material. The solvent is selected from the group consisting of isopropyl sulfide, dimethyl trithiocarbonate, undercane, hexadecane, octanethiol, undecanethiol, hexadecanethiol, and mixtures thereof. The SE material particles are ball milled such that at least part of the SE material particles break down into smaller particles. While performing the ball milling, the SE material particles and the milled particles are completely submerged in the solvent. The milled SE material particles are then separated from the solvent and dried.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure relates to alloy electrodes, particularly, lithium-aluminum (LiAl) alloy anodes and/or anode layers, for all solid state batteries, and methods of making anodes and/or anode layers.

### Secondary Batteries

Secondary batteries have become increasingly desirable power sources for a wide range of various electronic devices, such as cars, computers, cell phones, tools, scooter, bikes, electronic automobiles, power storage systems, drones, and other devices. Among secondary batteries, lithium-based batteries have gained particular prominence due to their ability to provide a desirable balance of voltage and energy density. Traditionally, lithium secondary batteries include a liquid electrolyte, typically comprising a lithium salt dissolved in an organic solvent. However, there has been growing interest in developing an all solid-state lithium secondary battery as an alternative to conventional liquid electrolyte-based systems. Solid-state batteries offer potential advantages in terms of safety, stability, and energy density. Despite these potential benefits, the development of practical all solid-state lithium secondary batteries faces several significant challenges.

### Challenges of All Solid-State Secondary Batteries

One challenge in solid-state battery design is achieving and maintaining sufficient lithium ion diffusivity within the solid electrolyte material. Further, volume changes (e.g. swelling and shrinking) of certain components of the battery—such as the electrode—may occur during discharging and charging of the battery. These volume changes may lead to mechanical stress or result in a loss of contact between various components within the battery structure. The loss of contact between battery components can cause degradation of charging and discharging characteristics, as well as deterioration of overall battery capacity. Researchers and engineers in the field of energy storage are actively working to address these challenges. Efforts are focused on developing new materials and battery designs that can achieve desirable lithium ion diffusivity while also accommodating the mechanical stresses associated with battery cycling. Improving the stability of interfaces within solid-state batteries remains an area of investigation. Overcoming the current limitations of solid-state battery systems could potentially lead to significant advancements in energy storage capabilities for a wide range of applications.

### No Admission of Prior Art

The discussion in this section is intended to provide background information related to the present disclosure and does not constitute an admission of prior art.

### SUMMARY

### Method of Preparing Solid Electrolyte Material

One aspect of the present disclosure provides a method of preparing a solid electrolyte (SE) material through a controlled wet ball milling process. In the initial step, SE material particles that may contain a sulfide-based compound are combined with a selected solvent and milling balls in such a way that both the particles and the balls are completely submerged in the solvent. The solvent is carefully chosen from a group that includes isopropyl sulfide, dimethyl trithiocarbonate, undercane, hexadecane, octanethiol, undecanethiol, hexadecanethiol, or mixtures thereof. During the milling process, the mechanical energy imparted by the milling balls causes at least a portion of the SE material particles to break down into smaller fragments, referred to as “milled particles.” It is crucial that the particles remain fully immersed in the solvent throughout this operation. Once milling is complete, the milled particles are separated from the solvent and subsequently dried to yield the final SE material.

### Solvents with Thiol Group

In some embodiments, the solvent is specifically selected from octanethiol, undecanethiol, hexadecanethiol, or their mixtures. Here, the thiol group of these compounds chemically interacts with the sulfur atoms present on the surface of the sulfide-containing SE particles. This interaction results in the orientation of the solvent's hydrophobic hydrocarbon tail outward from the particle surfaces, effectively forming a lipid-like barrier. This barrier may serve to stabilize the particles or modify their surface properties, enhancing their performance in subsequent applications.

### Amounts of Components

The process further specifies the weight ratios among the components. The ratio of solvent to SE material particles can range from about 0.4:1 to about 10:1, with a more optimized ratio around 5:1. Likewise, the milling balls are used in a weight ratio relative to the SE particles that typically falls between about 10:1 and 25:1, with a preferred ratio near 20:1. In practical terms, the amount of SE material particles used is generally between 100 mg and 500 mg, while the solvent weight is maintained between 200 mg and 1000 mg. The milling balls themselves are selected based on their weight, typically ranging from 200 mg to 12,500 mg, and they usually have a diameter between about 1.5 mm and 3 mm, with 1.5 mm often being ideal.

### Ball Milling Parameters

The ball milling parameters can vary to suit different processing needs. One set of conditions involves operating the mill at speeds between about 300 and 700 RPM for durations ranging from 1 to 2 hours (for example, 500 RPM for 2 hours). Alternatively, the process may be performed at a slower speed—between 20 and 60 RPM—for an extended period of about 10 to 15 hours, with a specific example being 20 RPM for 12 hours. The choice of parameters influences the final particle size distribution, with the original SE material particles typically ranging from 1 μm to 50 μm in size, and the resulting milled particles generally falling between 500 nm and 25 μm.

### Halogenated Lithium Phosphorous Sulfide

In some specific embodiments, the SE material particles are comprised of halogenated lithium phosphorous sulfide (LPS-X) particles, where “X” represents a halogen such as Cl, Br, or I, or combinations thereof. In particular, the method may use LPS-Cl particles, which are a common choice for solid-state electrolyte applications.

### Separation and Drying

Following the ball milling, the process involves a separation step where the milled particles are isolated from the solvent. The isolated particles are then dried, resulting in a solid electrolyte material that is ready for use.

### Manufacturing of All-Solid-State Lithium Batterie

The method is also applicable to the manufacturing of all-solid-state lithium batteries. In such applications, the prepared solid electrolyte layer is integrated into the battery assembly by positioning it between a cathode and an anode, thereby forming a complete battery cell. This integration highlights the practical importance of the controlled wet ball milling process in producing high-quality solid electrolytes for advanced energy storage systems.

### EXEMPLARY EMBODIMENTS

These and other features of the present disclosure may be understood from the following detailed description and will become more fully apparent from the exemplary embodiments of the present disclosure. Also, it will be easily understood that the objects and advantages of the present disclosure may be realized by the means shown in the appended claims and combinations thereof.

### Summary Not Limiting

It is understood that this disclosure is not limited to the examples summarized in this Summary. Various other aspects are described and exemplified herein.

### BRIEF DESCRIPTION OF THE DRAWINGS

FIG. 1A shows the electrochemical performance of a pellet cell including a cathode composite with the LPSCl ball-milled in the presence of isopropyl sulfide using a digital tube roller from Example 1.2.

FIG. 1B shows the electrochemical performance of a pellet cell including a cathode composite with un-milled LPSCl.

FIG. 2 is an example of an all solid state battery according to one embodiment.

### Exemplifications Not Limiting

The exemplifications set out herein illustrate certain non-limiting embodiments, in one form, and such exemplifications are not to be construed as limiting the scope of the appended claims in any manner.

### DETAILED DESCRIPTION

### Examples and Embodiments

The presently disclosed subject matter now will be described and discussed in more detail in terms of some specific embodiments and examples with reference to the accompanying drawings, in which some, but not all embodiments of the invention are shown. Like numbers refer to like elements or parts throughout unless otherwise referenced. The presently disclosed subject matter may be embodied in many different forms and should not be construed as limited to the specific embodiments set forth herein. Rather, these embodiments are provided so that this disclosure will satisfy applicable legal requirements. Indeed, many modifications and other embodiments of the presently disclosed subject matter will come to the mind of one skilled in the art to which the presently disclosed subject matter pertains. Therefore, it is to be understood that the presently disclosed subject matter is not to be limited to the specific embodiments disclosed and that modifications and other embodiments are intended to be included within the scope of the appended claims.

### Claim Interpretation

Hereinafter, the present disclosure will be described in detail. It should be understood that the terms or words used in the specification and the appended claims should not be construed as limited to general and dictionary meanings, but rather interpreted based on the meanings and concepts corresponding to the technical aspects of the present disclosure on the basis of the principle that the inventor is allowed to define terms appropriately for the best explanation. Therefore, the aspects of the disclosure described herein and the elements shown in the drawings are just aspects of the present disclosure, but not intended to fully describe the technical aspects of the present disclosure, so it should be understood that other equivalents and modifications could have been made thereto at the time the application was filed.

### Technical Terms

Unless defined otherwise, all the technical and scientific terms used herein have the same meanings as commonly known by a person skilled in the art. In the case that there is a plurality of definitions for the terms herein, the definitions provided herein will prevail.

### DEFINITIONS

### “A,” “An” And “The”

As used herein, the singular form of a word includes the plural, unless the context clearly dictates otherwise. The plural encompasses the singular and vice versa. Thus, the references “a,” “an” and “the” are generally inclusive of the plurals of the respective terms. For example, while the present disclosure has been described in terms of “a” layer, “a” substrate, “a” cell, and the like, more than one of these and other components, including combinations, can be used.

### “About”, “Approximately”, And “Substantially”

The term “about” indicates and encompasses an indicated value and a range above and below that value. As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. In certain embodiments, the term “about” indicates the designated value ±10%, ±5%, or ±1%. In certain embodiments, the term “about” indicates the designated value ±one standard deviation of that value.

### “Comprise,” “Consisting Essentially Of”, And “Consisting Of”

The words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may or may not lack any element that is not specifically disclosed herein. Thus, a disclosure of an embodiment defined using the term “comprising” is also a disclosure of embodiments “consisting essentially of” and “consisting of” the disclosed components. The phrase “consisting essentially of” limits the scope of the disclosed components to the specified materials or steps and those that do not materially affect the basic and novel characteristics of the disclosed invention. The phrase “consisting of” excludes any element, step, or ingredient not specified.

### “And/Or”

The term “and/or” used in the context of “X and/or Y” should be interpreted as “X,” “Y,” or “X and Y.”

### “On” And “Over”

As used herein, the terms “on,” “applied over,” “applied on,” “formed over,” “formed on, “deposited over,” “deposited on,” “overlay,” “provided over,” “provided on,” and the like, mean formed, overlaid, deposited, or provided on but not necessarily in contact with the surface. For example, a formed layer “applied over” a substrate layer does not preclude the presence of one or more other layers of the same or different composition located between the formed layer and the substrate layer.

### Markush Group

As used herein, the term “combination thereof” included in any Markush-type expression means a combination or mixture of one or more elements selected from the group of elements disclosed in the Markush-type expression, and refers to the presence of one or more elements selected from the group. The term “combinations thereof’ includes every possible combination of elements to which the term refers.

### “Between”

As used herein, the expression “between” is inclusive of end points.

### Numerical Ranges

Furthermore, all numerical ranges herein should be understood to include all integers, whole or fractions, within the range. Moreover, any numerical range recited herein is intended to include all sub-ranges subsumed therein, and these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth. When ranges are given, any endpoints of those ranges and/or numbers within those ranges can be combined with the scope of the present disclosure.

### Precision of Numbers

As used herein, unless otherwise expressly specified, all numbers, such as those expressing values, ranges, amounts, or percentages, may be read as if prefaced by the word “about,” even if the term does not expressly appear. “Including,” “such as,” “for example,” and like terms mean “including/such as/for example but not limited to.”

### Combination of Embodiments

As used herein, the term “example,” particularly when followed by a listing of terms, is merely exemplary and illustrative, and should not be deemed to be exclusive or comprehensive. Any embodiment disclosed herein can be combined with any other embodiment disclosed herein unless explicitly indicated otherwise.

### Particle Size

As used herein, particle size refers to the mean particle diameter (D₅₀) as measured using microscopy (e.g., optical microscopy, electron microscopy, scanning electron microscopy (SEM), transmission electron microscopy (TEM), atomic force microscopy (AFM), confocal microscopy, or fluorescence microscopy). The size can be the diameter of spherical particles or the length along the largest dimension of ellipsoidal or otherwise irregularly shaped particles. As used herein, “D₅₀” of particles refers to the diameter at which 50% of the particles have a smaller diameter.

### SOLID ELECTROLYTE MATERIAL PARTICLE SIZE

### Ion Transport

The size of solid electrolyte material particles plays a fundamental role in determining the performance and stability of all-solid-state batteries. In general, particle size influences critical factors such as ionic conductivity, interfacial contact, chemical reactivity, mechanical integrity, and manufacturability. Smaller solid electrolyte particles, in particular, offer distinct advantages due to their high surface area to volume ratio. This increased surface area enhances ion transport by improving interfacial contact between the electrolyte and electrode materials, thereby reducing ionic resistance and facilitating faster charge and discharge rates. In composite electrodes, small electrolyte particles help create continuous ion-conducting pathways, enabling better charge transfer kinetics and enhancing power density.

### Packing Density

Another key advantage of small electrolyte particles is their ability to improve packing density. A well-packed solid electrolyte minimizes voids that could otherwise disrupt ion flow, ensuring more consistent and stable performance. This is particularly important in all-solid-state batteries, where strong interfacial contact between the solid electrolyte and electrodes is essential for efficient ion transport and long-term cycling stability. By reducing the particle size, the solid electrolyte material can integrate more seamlessly with active electrode materials, thereby lowering interfacial resistance and enhancing battery durability.

### Chemical Reactivity and Grain Boundaries

However, despite these benefits, small solid electrolyte particles introduce several challenges. One major issue is their increased chemical reactivity. The high surface energy of smaller particles makes them more prone to side reactions with electrode materials, which can lead to the formation of interfacial degradation layers. These unwanted reactions may reduce ionic conductivity over time, negatively impacting battery longevity and overall efficiency. Additionally, as the particle size decreases, the number of grain boundaries within the material increases. While some grain boundaries can serve as fast ion transport pathways, others may become barriers, increasing resistance and hindering ion mobility. Proper engineering of these grain boundaries is crucial to ensuring that they contribute positively to battery performance.

### Tendency to Agglomerate

Another drawback of small electrolyte particles is their tendency to agglomerate. If not properly stabilized, nanoparticles can cluster together, forming non-uniform structures that disrupt ion transport and lead to performance inconsistencies. Addressing this issue requires advanced synthesis and processing methods to ensure uniform particle dispersion and stable integration into the battery system.

### Mechanical Stability

Mechanical stability can also be a concern when working with small electrolyte particles. As solid-state batteries undergo repeated charge and discharge cycles, materials experience expansion and contraction, which can introduce mechanical stress. Smaller particles, particularly in thin electrolyte layers, may be more prone to cracking or structural failure, increasing resistance and potentially leading to battery degradation over time. Developing mechanically robust materials while maintaining the advantages of small particle size is a key area of ongoing research.

### BALL-MILLING

### Ball Milling Generally

Ball milling is a valuable technique for mixing and preparing materials for solid-state batteries. Ball milling is a mechanical technique widely used to grind powders into fine particles and mix materials in various applications, including the preparation of solid-state battery components. In the context of solid-state batteries, ball milling is often employed to mix and/or blend the electrode materials, solid electrolytes, and/or other components. Example ball milling devices include planetary ball mills, attritor mills, vibratory ball mills, and tube rollers. These devices typically consist of a rotating or vibrating chamber, container, or tube containing grinding balls made of materials such as steel, ceramic, or zirconia.

### Homogeneous Mixing

Ball milling is effective in achieving a homogeneous mixture of different powders. This is crucial for ensuring uniform distribution of components in the electrode materials and solid electrolytes, which, in turn, impacts the overall performance of the battery.

### Reducing Particle Size

Ball milling can reduce the particle size of the materials involved, leading to increased surface area and improved reactivity. Here, the ball-milling of the mixture reduces particle sizes in the mixture, creating more surface areas compared to those in the mixture prior to the ball-milling of the mixture. Smaller particle sizes can enhance the kinetics of electrochemical reactions, contributing to better battery performance. The micron scale particles (<10 μm) in the composite material provided herein realize high utilization without compromising stability.

### Other Benefits of Ball Milling

Ball milling has other benefits, such as facilitating the formation of a well-defined interface between the particles. This is important for promoting efficient ion transport and minimizing interfacial resistance within the solid-state battery. The milling process can also influence the morphology of the materials, including particle shape, size, and distribution. Controlling these aspects is important for achieving the desired electrochemical properties and overall performance of the solid-state battery.

### Wet Ball Milling Generally

Wet ball milling is used to reduce particle size and achieve homogeneous dispersions by grinding materials in the presence of a liquid medium. In this process, the ball mill is filled with grinding media, the material to be milled, and a suitable liquid (typically water or an organic solvent). The liquid not only facilitates the milling by reducing friction and wear but also helps control the temperature during the process, prevents dust formation, and can reduce the risk of oxidation or contamination.

### Mechanical Attrition

At the core of wet ball milling is the principle of mechanical attrition. As the container rotates, the grinding media are lifted and then dropped or sheared, imparting impact and shear forces to the material. This results in the fracturing of large particles into smaller ones and promotes uniform particle size distribution. The liquid medium plays a crucial role by providing a cushion that reduces heat buildup and by acting as a dispersant that keeps the milled particles separated, which is particularly important when aiming for smaller particle sizes or preventing agglomeration.

### Parameters of Wet Ball Milling Generally

Several process parameters critically influence the efficiency and outcome of wet ball milling. These include the rotation speed of the mill, the size, density, and quantity of the grinding media, and the ball-to-powder ratio. The choice of liquid is also pivotal; its viscosity, surface tension, and chemical compatibility with the material can significantly affect milling kinetics. Moreover, milling duration, temperature control, and even the design of the milling chamber can be optimized to tailor the process for specific materials and desired particle size distributions.

### Liquid Medium Removal and Selection Generally

While wet ball milling offers several advantages—such as improved heat management, reduced contamination, and enhanced dispersion—it also presents challenges. The subsequent need to remove the liquid from the milled product (usually via drying) can add extra processing steps and costs. Moreover, the selection of the liquid medium must be carefully considered to avoid unwanted chemical reactions or changes in material properties. Achieving optimal results requires careful consideration of milling parameters, selection of an appropriate liquid medium, and balancing the benefits against potential additional processing requirements.

### Energy Considerations

Ball milling is an energy-intensive process, and the duration and speed of milling need to be carefully controlled to avoid excessive heating, which could lead to undesired reactions or damage to the materials.

### PREPARING SOLID ELECTROLYTE MATERIAL

### Method of Preparing Solid Electrolyte Material

One aspect of the present disclosure provides a method of preparing a solid electrolyte (SE) material through a controlled wet ball milling process, which not only improves the microstructural characteristics of the solid electrolyte but also contributes to the overall efficiency, safety, and longevity of all-solid-state batteries.

### Controlled Fragmentation

By milling the solid electrolyte particles in a carefully selected solvent, this method enables precise control over the particle size distribution, ensuring that the resulting material consists of a uniform and finely tuned range of particles. The solvent acts as both a medium for energy transfer and a dispersing agent, reducing the chances of particle agglomeration and allowing for a more even breakdown of materials. This controlled fragmentation helps achieve a consistent size range, which is particularly important for solid electrolyte applications where particle uniformity directly impacts the material's packing efficiency and electrochemical properties.

### Minimized Ion Transport Resistance

Such uniformity minimizes ion transport resistance within the electrolyte layer. When particles are consistently sized, they pack more densely, reducing gaps and voids that could otherwise disrupt the continuous ionic pathways needed for efficient lithium-ion conduction. A well-packed solid electrolyte layer ensures a stable and low-resistance interface between the electrolyte and the electrode materials, which is essential for optimizing the charge and discharge kinetics of all-solid-state batteries.

### Enhanced Mechanical Integrity and Longevity

Additionally, a controlled particle size distribution promotes the formation of dense, defect-free electrolyte layers. Inconsistent or overly broad particle size distributions can lead to structural weaknesses, including the presence of microcracks and irregular voids, which may compromise mechanical stability and increase the likelihood of lithium dendrite formation. By achieving a highly uniform particle size, the processed material contributes to a more structurally robust electrolyte layer, enhancing both the mechanical integrity and longevity of the battery.

### Improved Battery Performance

Ultimately, this level of control over particle size distribution directly translates to improved battery performance. Enhanced ionic conductivity, lower interfacial resistance, and increased structural stability all contribute to greater energy efficiency, longer cycle life, and improved safety in all-solid-state batteries. By refining the milling process and optimizing the choice of solvent, the material properties can be fine tubed to meet the demanding requirements of next-generation energy storage technologies.

### Dispersing Medium

The solvent used in the wet milling process plays a multifaceted role that significantly influences the outcome of the solid electrolyte material. One of its primary functions is to act as a dispersing medium, ensuring that the electrolyte particles remain uniformly distributed throughout the milling environment. This uniform dispersion minimizes particle agglomeration, allowing the milling balls to more effectively break down the particles into a consistent size range. By preventing clumping, the solvent contributes directly to achieving a narrow particle size distribution, which is essential for forming dense, defect-free electrolyte layers that promote efficient ion transport.

### Protection

The careful selection and use of an appropriate solvent are key to optimizing the milling process, enhancing the structural and electrochemical properties of the solid electrolyte, and ultimately improving the performance of all-solid-state batteries. During the wet ball milling process, the solvent plays a crucial role in protecting the solid electrolyte material from unwanted chemical reactions that can occur when fresh surfaces and microcracks are exposed. As mechanical forces break down the particles, new reactive sites are generated—sites that are highly susceptible to oxidation or other degradation reactions if exposed to oxygen, moisture, or contaminants. When the solvent covers the particle surfaces and fills in the cracks, it acts as a physical barrier that limits the access of these reactive species, thereby helping to preserve the intrinsic properties of the solid electrolyte.

### Chemical Passivation

Solvents that contain functional groups, such as thiol groups found in octanethiol, undecanethiol, or hexadecanethiol, offer the additional benefit of chemical passivation. In these cases, the functional groups can interact directly with the surface atoms of sulfide-based electrolyte particles, forming a protective layer that chemically stabilizes the surface and prevents further reactions. This passivation not only limits oxidation but also can improve interfacial compatibility with other battery components by reducing surface energy and interfacial resistance.

### Physical Barrier

On the other hand, solvents that lack specific functional groups, such as isopropyl sulfide or hexadecane, do not chemically bond to the particle surfaces. Instead, their protective effect is primarily physical. These inert solvents still provide an effective barrier by fully surrounding the particles, filling in any cracks or defects that form during milling, and thereby preventing direct contact with environmental oxidizers. Although they may not offer the same level of chemical stabilization as functionalized solvents, their inert nature means they are less likely to participate in unwanted side reactions, making them suitable choices in situations where a non-reactive medium is preferred.

### Ensuring Stability

In both cases, the careful selection of the solvent—whether it is functionalized for chemical passivation or inert for a purely physical barrier—ensures that the milled solid electrolyte material remains stable and retains its desired electrochemical performance for use in all-solid-state batteries.

### Other Benefits

Moreover, the solvent's viscosity, polarity, and boiling point help regulate the energy transfer during milling, ensuring that the process remains efficient while avoiding excessive heat generation that might otherwise degrade the material. Furthermore, the controlled conditions—such as the precise ratios of solvent to particles and the careful selection of milling speeds and durations—ensure reproducibility and scalability of the process, making it attractive for industrial applications.

### Complete Submersion

In the initial step, SE material particles are combined with a selected solvent and milling balls in a milling chamber or container. Both the particles and the balls are completely submerged in the solvent. The SE material particles and the milling balls are completely covered and enveloped by the solvent, with no portion left exposed to air or dry. The solvent level in the milling chamber is sufficiently high to ensure that every particle and milling ball is beneath the surface of the liquid, preventing any direct contact with the atmosphere. Proper submersion is critical to maintaining a consistent milling environment and achieving the desired material properties. Additionally, uniform dispersion of the SE particles within the solvent is necessary to prevent agglomeration and ensure even particle size reduction. The milling action relies on constant interaction between the milling balls, particles, and solvent, so maintaining a homogeneous mixture is essential. Further, any air pockets within the solvent or trapped between particles can interfere with the milling process by reducing efficiency and causing inconsistencies in particle distribution. Techniques such as degassing, proper mixing, or adjusting the solvent volume can help eliminate trapped air.

### Solvents

The solvent is carefully chosen and may be one or more of isopropyl sulfide, dimethyl trithiocarbonate, undercane, hexadecane, octanethiol, undecanethiol, or hexadecanethiol, among others.

### Forming Milled Particles

During the milling process, the mechanical energy imparted by the milling balls causes at least a portion of the SE material particles to break down into smaller fragments, referred to as “milled particles.” The mechanical forces generated by the milling balls collide with the SE particles inside a rotating or vibrating milling chamber or container. As the milling balls move, they transfer kinetic energy to the SE particles, causing them to fracture and break apart. The repeated collisions create a continuous cycle of particle size reduction, transforming larger SE particles into smaller fragments over time.

### Impact Forces

The breakdown of SE material particles occurs primarily through impact forces. When the milling balls strike the particles at high velocities, they generate intense localized stress. This stress exceeds the material's structural strength, causing the particles to shatter into smaller pieces. The impact force is particularly effective in breaking down larger, more brittle SE particles, leading to a significant reduction in size within a short period.

### Shear and Attrition Forces

In addition to impact forces, shear and attrition forces play a crucial role in breaking down SE particles. As the milling balls roll and slide against each other within the chamber, they exert shear stress on the particles trapped between them. This grinding action gradually wears down the SE particles, producing finer and more uniform powder. Attrition forces further contribute to the breakdown process by continuously scraping and refining particle surfaces, ensuring a more consistent final particle size.

### Efficiency of Particle Breakdown

The efficiency of particle breakdown depends on several factors, including milling speed, ball-to-powder ratio, milling time, and the size and material of the milling balls. Higher milling speeds and longer durations result in greater energy transfer, accelerating the breakdown process. Using an optimal ball-to-powder ratio ensures that the SE particles experience maximum collision events without excessive agglomeration. The choice of milling ball material, such as zirconia or stainless steel, also affects the effectiveness of particle breakdown, as harder materials generate stronger impact forces.

### Immersion

The particles, including the initial SE material particles and the milled particles, remain fully immersed in the solvent throughout the milling process. The solvent is present in a volume that ensures all solid components remain fully immersed at all times. This prevents dry areas from forming, which could lead to uneven milling or unwanted contamination. Ensuring that all solid components are consistently submerged also reduces the risk of oxidation or other unwanted chemical reactions that could occur if the SE particles are exposed to air. The solvent volume is sufficient not only to cover the solids initially but also to account for potential absorption, evaporation, or loss during the milling process. If too little solvent is used, partial exposure of the solids may occur over time, leading to inefficient milling or material degradation. By carefully controlling the solvent level and maintaining full submersion, the process benefits from enhanced energy transfer, improved particle interaction, and optimized material performance.

### Thiol Solvents

In some embodiments, the solvent is specifically selected from the group consisting of octanethiol, undecanethiol, hexadecanethiol, and mixtures thereof.

### Lipid Barrier

The thiol group of these compounds chemically interacts the surface of the SE particles. For example, when the SE material contains sulfide, the thiol group interacts with one or more sulfur atoms present on the surface of at least a portion of the sulfide-containing SE particles. This interaction results in the orientation of the solvent's hydrophobic hydrocarbon tail outward from the particle surfaces, effectively forming a lipid-like barrier. This barrier can inhibit particle agglomeration, stabilize the particles, modify their surface properties, and/or improve interfacial compatibility within the battery, which is essential for achieving stable electrochemical performance over extended cycles.

### Weight Ratio of Solvent to SE Material Particles

The weight ratio of solvent to SE material particles can range from about 0.4:1 to about 10:1, such as at or about 0.4:1, 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2:1, 2.1:1, 2.2:1, 2.3:1, 2.4:1, 2.5:1, 2.6:1, 2.7:1, 2.8:1, 2.9:1, 3:1, 3.1:1, 3.2:1, 3.3:1, 3.4:1, 3.5:1, 3.6:1, 3.7:1, 3.8:1, 3.9:1, 4:1, 4.1:1, 4.2:1, 4.3:1, 4.4:1, 4.5:1, 4.6:1, 4.7:1, 4.8:1, 4.9:1, 5:1, 5.1:1, 5.2:1, 5.3:1, 5.4:1, 5.5:1, 5.6:1, 5.7:1, 5.8:1, 5.9:1, 6:1, 6.1:1, 6.2:1, 6.3:1, 6.4:1, 6.5:1, 6.6:1, 6.7:1, 6.8:1, 6.9:1, 7:1, 7.1:1, 7.2:1, 7.3:1, 7.4:1, 7.5:1, 7.6:1, 7.7:1, 7.8:1, 7.9:1, 8:1,8.1:1, 8.2:1, 8.3:1, 8.4:1, 8.5:1, 8.6:1, 8.7:1, 8.8:1, 8.9:1, 9:1, 9.1:1, 9.2:1, 9.3:1, 9.4:1, 9.5:1, 9.6:1, 9.7:1, 9.8:1, 9.9:1, or 10:1. The weight ratio of the solvent to the SE material particles can also be less than about 0.4:1 or higher than about 10:1, such as 0.3:1, 0.2:1, 0.1:1, 11:1, 12:1, 13:1, 14:1, or 15:1, etc. In embodiments, the weight ratio of solvent to SE material particles can be within a range formed by selecting any two numbers provided herein, such as from about 0.3:1 to about 1:1, from about 2:1 to about 5:1, from about 5:1 to about 8:1, from about 9:1 to about 13:1, etc.

### Weight Ratio of Milling Balls to SE Material Particles

The milling balls are used in a weight ratio relative to the SE particles that typically falls between about 10:1 and 25:1, such as at or about 10:1, 11:1, 12:1, 13:1, 14:1, 15:1, 16:1,17:1, 18:1, 19:1, 20:1, 21:1, 22:1, 23:1, 24:1, or 25:1. The weight ratio of the milling balls to the SE particles can also be less than about 10:1 or greater than 25:1, such as 5:1, 6:1, 7:1, 8:1, 9:1,26:1, 27:1, 28:1, 29:1, 30:1, etc. In embodiments, the weight ratio of the milling balls to the SE material particles can be within a range formed by selecting any two numbers provided herein, such as from about 5:1 to about 12:1, from about 15:1 to about 25:1, from about 25:1 to about 28:1, from about 18:1 to about 23:1, etc.

### Weight of SE Material Particles

The amount of SE material particles used is generally between about 100 mg and about 500 mg, such as at or about 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or 500 mg. The amount of SE material particles used may also be less than about 100 mg or greater than about 500 mg, such as at or about 10, 20, 30, 40, 50, 60, 70, 80, 90, 550, 600, 650, 700, 750, 800, 850, 900, 950, or 1000 mg, etc. In embodiments, the amount of the SE material particles can be within a range formed by selecting any two numbers provided herein, such as from about 50 to about 100, from about 100 to 200, from about 250 to 350, from about 450 to about 550, from about 600 to about 750 mg, etc.

### Weight of Solvent

The solvent weight is maintained between about 200 mg and about 1000 mg, such as at or about 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 mg. The solvent weight may also be less than about 200 mg or greater than about 1000 mg, such as at or about 100, 150, 1100, 1200, 1300, 1400, 1500, 2000, 3000, 4000, or 5000 mg, etc. In embodiments, the weight of the solvent can be within a range formed by selecting any two numbers provided herein, such as from about 100 to about 250, from about 250 to about 500, from about 500 to about 750, from about 800 to about 1500 mg, etc.

### Weight of Milling Balls

The weight of the milling balls may typically range from about 200 mg to about 12500 mg, such as at or about 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 2000, 3000, 4000, 5000, 6000, 7000, 8000, 9000, 10000, 10500, 11000, 11500, 12000, or 12500 mg. The weight of the milling balls may also be less than about 200 mg or greater than about 12500 mg, such as at or about 100, 110, 120, 130, 140, 150, 160, 170, 180, 190, 13000, 13500, 14000, 14500, 15000, 15500, 16000, 16500, 17000, 17500, 18000, 18500, 19000, 19500, 20000 mg, etc. In embodiments, the weight of the milling balls can be within a range formed by selecting any two numbers provided herein, such as from about 100 to about 250, from about 250 to about 500, from about 1500 to about 2750, from about 8000 to about 15000 mg, etc.

### Diameter of Milling Balls

The milling balls usually have a diameter between about 1.5 mm and about 3 mm, such as at or about 1.5, 1.6, 1.7, 1.8, 1.9, 2, 2.1, 2.2, 2.3, 2.4, 2.5, 2.6, 2.7, 2.8, 2.9, or 3 mm. The milling balls may have a diameter smaller than about 1.5 mm or larger than about 3 mm, such as at or about 1, 1.1, 1.2, 1.3, 1.4, 3.1, 3.2, 3.3, 3.4, 3.5, 3.6, 3.7, 3.8, 3.9, 4 mm, etc. In embodiments, the diameter of the milling balls can be within a range formed by selecting any two numbers provided herein, such as from about 1 to about 2, from about 1.5 to about 2.5, from about 2.5 to about 3.5 mm, etc.

### Ball-Milling Speed

The ball-milling may be conducted at a speed of about 5 to about 1000 RPM, for example, at or about 5, 10, 15, 20, 25, 30, 35, 40, 45, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 RPM. The milling may also be conducted at a speed lower than about 10 RPM or higher than about 1000 RPM, such as at or about 5, 6, 7, 8, 9, 1100, 1200, 1300, 1400, or 1500 RPM, etc. In embodiments, the speed at which the ball-milling of the mixture is conducted can be within a range formed by selecting any two numbers listed above or by selecting any two numbers provided herein, such as from about 10 to about 60, from about 20 to about 60, from about 50 to about 100, from about 200 to about 800, from about 300 to about 700, from about 500 to about 550, from about 500 to about 1000 RPM, etc.

### Ball-Milling Duration

The ball-milling may be conducted for about 1 minute to about 20 hours, for example, at or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59 minutes, 1, 2, 3, 4, 5, 6, 7, 8, 9, 10, 11, 12, 13, 14, 15, 16, 17, 18, 19, or 20 hours. The ball-milling may also be conducted for a duration shorter than about 1 minute or longer than about 20 hours, such as at or about 0.5, 0.6, 0.7, 0.8, 0.9 minute, 21, 22, 23, 24, 25, 26, 27, 28, 29, 30 hours, etc. In embodiments, the ball-milling can be conducted for a duration within a range formed by selecting any two numbers listed above or by selecting any two numbers provided herein, such as from about 1 to 2, from about 10 to about 15, from about 12 to about 20, from about 0.5 to about 5 hours, etc.

### Examples of Milling Parameters

The ball milling parameters can vary to suit different processing needs. One set of conditions involves operating the mill at speeds between about 300 and 700 RPM for durations ranging from 1 to 2 hours, for example, 500 RPM for 2 hours. Alternatively, the process may be performed at a slower speed—between 20 and 60 RPM—for an extended period of about 10 to 15 hours, with a specific example being 20 RPM for 12 hours. There can be many other sets of milling parameters.

### Wet Milling Devices

Wet ball milling can be conducted with high-energy or low-energy ball milling devices, and the choice of device may impact particle size reduction, material characteristics, and processing efficiency.

### High-Energy Ball Milling Devices

High-energy ball milling devices are designed to deliver significant mechanical energy to the materials being processed, resulting in rapid particle size reduction and enhanced reactivity. Among the key high-energy ball milling devices used for wet milling are, for example, planetary ball mills, vibratory ball mills, and attritor mills, although not limited thereto.

### Planetary Ball Mills

Planetary ball mills are widely used for their high energy efficiency and effectiveness in producing fine particles. These mills consist of several rotating jars that orbit around a central axis, with each jar containing milling balls and the material to be milled. The combination of rotational and orbital motion creates intense impact and shear forces, leading to effective size reduction. Planetary ball mills can produce very fine particle sizes, often down to the nanometer scale, and allow for precise control over milling parameters such as speed, time, and ball-to-powder ratio. However, they have limited processing capacity, making them less suitable for large-scale production, and their high energy consumption can lead to heat generation, potentially affecting sensitive materials. Here, when a planetary ball mill is used, multiple jars containing the SE particles, milling balls, and solvent are rotated simultaneously around their own axes and a central axis. This dual motion produces high-impact forces that can reduce particle size significantly, such as down to the nanometer scale, an attribute that is crucial for improving the interfacial contact between the electrolyte and the electrodes in all solid-state batteries. However, while these mills offer rapid and efficient particle size reduction, care must be taken to control parameters like milling time and energy input to avoid overheating or unwanted phase transformations in the sensitive electrolyte materials.

### Vibratory Ball Mills

Vibratory ball mills utilize high-frequency vibrations to agitate the milling balls and particles within the milling chamber. This method generates a combination of impact and shear forces, making it effective for rapid particle size reduction. For SE materials, this can result in a more homogeneous slurry and improved ionic pathways, both of which are beneficial for battery performance. Vibratory ball mills are efficient for achieving ultra-fine particle sizes with minimal milling time, making them particularly suitable for small batch processing and research and development applications. The continuous mixing action promotes uniform particle distribution, but these mills typically have a smaller volume capacity compared to other high-energy mills, and their high energy consumption may limit their use in large-scale applications.

### Attritor Mills

Attritor Mills, also known as stirred media mills, operate using a stationary milling chamber with a rotating agitator that stirs the milling balls and slurry. This design generates strong impact and shear forces, making attritor mills highly effective for wet milling applications requiring ultra-fine particle sizes. These mills generate consistent shear and impact forces that are ideal for producing ultra-fine SE particles while maintaining a uniform dispersion in the solvent. Their scalability and energy efficiency make them attractive for industrial applications where large volumes of SE material need to be processed with high precision. Attritor mills provide continuous milling, allowing for better process control and higher throughput compared to other types of ball mills. However, they require careful optimization of milling parameters to prevent excessive wear on the milling media and ensure consistent particle size reduction.

### Low-Energy Ball Milling Devices

In contrast to high-energy devices, low-energy ball milling options are designed for applications that require gentle mixing and dispersion rather than aggressive size reduction. These devices include digital tube rollers, ball mill jar rollers, and conical mills, among others. These devices are used where excessive mechanical stress must be avoided to preserve the crystallinity or specific microstructures of the SE material.

### Digital Tube Rollers

Digital tube rollers are low-energy devices that utilize rotating tubes to gently mix and agitate materials. These rollers can be filled with milling balls and a solvent, allowing for mild milling action that breaks down particles without generating excessive heat or mechanical stress. Digital tube rollers use slow, controlled rotations to achieve gradual particle size reduction, ensuring that the material's integrity is maintained.

### Ball Mill Jar Rollers

Ball mill jar rollers consist of a set of rollers that hold jars filled with materials and milling balls. As the rollers rotate, the jars move in a circular motion, facilitating a gentle grinding action. Ball mill jar rollers are effective for mixing and dispersing materials without subjecting them to the high forces associated with high-energy milling. Ball mill jar rollers gently agitate the materials in jars, providing sufficient mixing and dispersion without the high-energy impacts that could damage delicate SE structures. They are often used for small-scale applications and can accommodate a variety of materials.

### Conical Mills

Conical mills, also known as conical screen mills or hammer mills, can also be adapted for wet milling. These devices use a conical-shaped screen to achieve gentle size reduction while allowing for the incorporation of a liquid medium. The conical design promotes efficient mixing and dispersing, making them suitable when a combination of milling and blending is required.

### Selection of Device

The choice between high-energy and low-energy ball milling devices for wet milling is crucial for achieving desired material properties and processing efficiency. High-energy devices like planetary ball mills, vibratory ball mills, and attritor mills are excellent for producing ultra-fine particles quickly, while low-energy devices such as digital tube rollers and ball mill jar rollers provide gentle mixing and dispersion for sensitive materials. Conical mills further enhance the versatility of low-energy milling options. In the context of all solid-state batteries, the choice between high-energy and low-energy wet milling techniques is driven by the specific requirements of the electrolyte material. High-energy milling is often preferred when a rapid reduction to nano-sized particles is needed to enhance ion conductivity and electrode contact. Conversely, low-energy milling is beneficial when the preservation of material structure is critical to maintain the intrinsic properties of the SE. Ultimately, optimizing the wet milling process through careful selection of the milling device and precise control of milling parameters is vital to producing SE particles that meet the performance criteria of advanced all solid-state battery systems.

### Size of Original SE Material Particles

The original SE material particles have a size typically ranging from about 1 μm to about 50 μm in size, such as at or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 μm. The original SE material particles may also have a size smaller than about 1 μm or greater than about 50 μm, such as at or about 0.5, 0.6, 0.7, 0.8, 0.9, 51, 52, 53, 54, 55, 56, 57, 58, 59, 60, 65, 70, 75, 80, 85, 90, 95, or 100 μm, etc. In embodiments, the size of the original SE material particles may be within a range formed by selecting any two numbers provided herein, such as from about 0.5 to about 1.5, from about 1 to about 5, from about 10 to about 15, from about 20 to about 35, from about 40 to about 50, or from about 45 to about 65 μm, etc. The original SE material particles may have a mean size ranging from about 1 μm to about 50 μm in size, such as at or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 μm. The original SE material particles may also have a mean size smaller than about 1 μm or greater than about 50 μm, such as at or about 0.5, 0.6, 0.7, 0.8, 0.9, 51, 52, 53, 54, 55, 56, 57, 58, 59, 60, 65, 70, 75, 80, 85, 90, 95, or 100 μm, etc. In embodiments, the mean size of the original SE material particles may be within a range formed by selecting any two numbers provided herein, such as from about 0.5 to about 1.5, from about 1to about 5, from about 10 to about 15, from about 20 to about 35, from about 40 to about 50, or from about 45 to about 65 μm, etc.

### Size of Milled Particles

The resulted milled particles may have a size generally falling between about 500 nm and about 25 μm, such as at or about 500, 600, 700, 800, 900 nm, 1, 2, 3, 4, 5, 6, 7, 8, 9, 10, 11, 12, 13, 14, 15, 16, 17, 18, 19, 20, 21, 22, 23, 24, or 25 μm. The milled particles may also have a size smaller than about 500 nm or larger than about 25 μm, such as at or about 100, 200, 300, 400 nm, 26, 27, 28, 29, or 30 μm, etc. In embodiments, the size of the milled particles may be within a range formed by selecting any two numbers provided herein, such as from about 0.5 to about 1.5, from about 1 to about 5, from about 10 to about 15, from about 20 to about 25, etc. The milled particles may have a mean size generally falling between about 500 nm and about 25 μm, such as at or about 500, 600, 700, 800, 900 nm, 1, 2, 3, 4, 5, 6, 7, 8, 9, 10, 11, 12, 13, 14, 15, 16, 17, 18, 19, 20, 21, 22, 23, 24, or 25 μm. The milled particles may also have a mean size smaller than about 500 nm or larger than about 25 μm, such as at or about 100, 200, 300, 400nm, 26, 27, 28, 29, or 30 μm, etc. In embodiments, the mean size of the milled particles may be within a range formed by selecting any two numbers provided herein, such as from about 0.5 to about 1.5, from about 1 to about 5, from about 10 to about 15, from about 20 to about 25 μm, etc

### SE Material

The SE material particles may contain a sulfide-based compound. In some embodiments, the SE material particles contain halogenated lithium phosphorous sulfide (LPS-X) particles, where “X” represents a halogen such as Cl, Br, or I, or combinations thereof. In particular, the method may use LPS-Cl particles, which are a common choice for solid-state electrolyte applications. The SE material particles may contain one or more materials other than a sulfide-based material. More details of the SE material are provided in the “OTHER ASPECTS” section.

### Separation

After the milling, the next step is separating the milled SE particles from the solvent and any remaining milling balls. This separation process ensures that the final SE powder is free of contaminants and has the desired particle size distribution for further processing in all solid-state battery applications. The separation process typically begins with decantation or filtration to remove the bulk of the solvent from the milled slurry. Filtration can be carried out using fine mesh filters or membranes that are carefully chosen to retain the small SE particles while allowing the liquid solvent to pass through. In some cases, centrifugation is employed to accelerate the sedimentation of the heavier SE particles. Centrifugation helps in compacting the particles at the bottom of the vessel, thereby facilitating a more efficient removal of the solvent. It is also a useful method to separate the SE particles from any residual milling media that might be present in the slurry. Once the milled SE particles are separated from the bulk solvent, additional steps are often taken to ensure the purity and consistency of the powder. For example, if the milling media (such as balls or beads) remains mixed with the particles, sieving or additional filtration steps may be necessary. These methods help to physically separate the larger milling media from the finer SE particles, ensuring that the final product is free of any unintended contaminants.

### Drying

The final stage after the separation process is drying, which is crucial for removing any remaining solvent that could interfere with subsequent processing steps or affect the performance of the solid-state battery. Drying can be performed using various techniques, such as vacuum drying, freeze drying, or conventional oven drying, each selected based on the sensitivity of the SE material and the desired characteristics of the final powder. Care must be taken during drying to control the rate at which the solvent is removed; rapid drying can lead to particle agglomeration, while too slow a process might leave residual moisture that compromises the powder's stability.

### Separation and Drying

The separation and drying steps after wet ball milling are essential to produce a high-quality SE powder. These steps directly impact the electrochemical performance, particle uniformity, and overall reliability of the all solid-state batteries in which the electrolyte will be used.

### ALL-SOLID-STATE LITHIUM BATTERIES

### Method of Manufacturing Batteries

Another aspect of the present disclosure provides a method of manufacturing all-solid-state lithium batteries. In such applications, the prepared solid electrolyte layer is integrated into the battery assembly by positioning it between a cathode and an anode, thereby forming a complete battery cell. This integration highlights the practical importance of the controlled wet ball milling process in producing high-quality solid electrolytes for advanced energy storage systems.

More details are provided in the “OTHER ASPECTS” section below.

### OTHER ASPECTS

The following provides other aspects of the present disclosure. The additional features, embodiments and examples discussed below will be applicable to various aspects of the invention discussed above. In case there is a conflict between information in the foregoing discussions and information in the following discussions, however, the information in the foregoing section should apply.

### Solid State Lithium Ion Batteries

A solid state battery can receive a charge and discharge an electrical load various times. A solid state battery includes electrodes, a cathode electrode and an anode electrode, and an electrolyte to allow lithium ions to travel between the electrodes. In contrast to conventional liquid electrolyte batteries, the solid state battery does not include any flowable liquids. Forming a circuit between the electrodes causes electricity to flow between the electrodes. During charging of the lithium ion rechargeable battery, lithium ions are emitted from the cathode electrode and are intercalated into an active material of the anode electrode. During discharging of the lithium ion rechargeable battery, lithium ions are emitted from the anode electrode and are intercalated into an active material of the cathode electrode. As lithium ions reciprocate between the electrodes, they transfer energy.

### Solid State Battery Configuration

The present disclosure provides a solid state battery 100 comprising a cathode electrode 102, an anode electrode 104, and a solid electrolyte layer 106 intermediate the cathode electrode 102 and the anode electrode 104. While listed as exemplary, the solid state battery 100 does not require all of these components. For example, in some configurations, such as in anodeless system, the anode electrode 104 may be omitted.

### Optional Additional Layers

The solid state battery 100 can optionally comprise an additional layer or layers, such as, for example, a separator layer, a protective layer, an inhibitor layer, a solid electrolyte interface layer, or a combination thereof.

### Protective Layer

For example, a protective layer may be incorporated between the electrodes 102 and 104 and the solid electrolyte layer 106. The protective layer may also serve to mitigate dendrite formation, particularly on the anode side, thereby improving the overall cycle life and safety of the battery.

### Protective Layer Materials

This protective layer may comprise materials such as lithium phosphate, lithium titanate, or lithium lanthanum zirconium oxide (LLZO), which can help prevent undesirable side reactions at the electrode-electrolyte interface.

### Separator Layer

A separator layer may also be included in some configurations of the solid state battery 100. These separator layers can provide additional mechanical support to the battery structure while still allowing for efficient ion transport. The separator layer may also be designed to have a gradient structure, with properties optimized for contact with both the cathode and anode materials.

### Separator Layer Materials

While traditional liquid electrolyte batteries often use porous polymer separators, solid state batteries may employ thin ceramic or glass-ceramic layers as separators. Materials such as LLZO, LATP (lithium aluminum titanium phosphate), or LAGP (lithium aluminum germanium phosphate) may be used for this purpose.

### Solid State Battery Cell

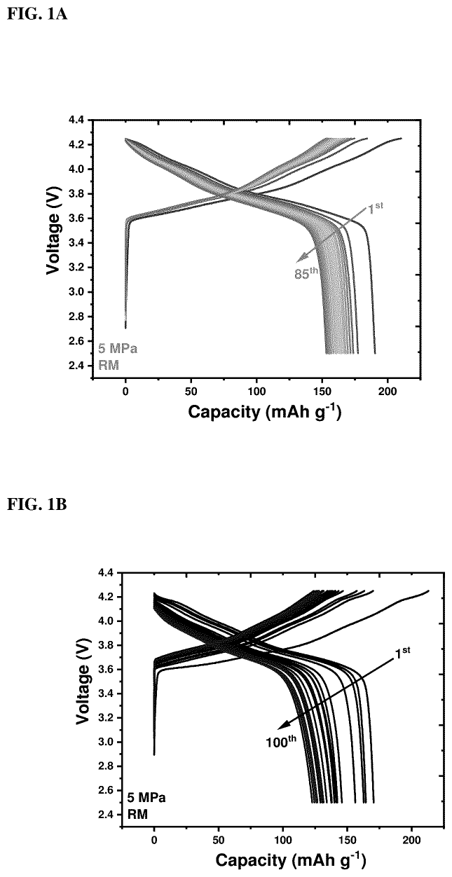

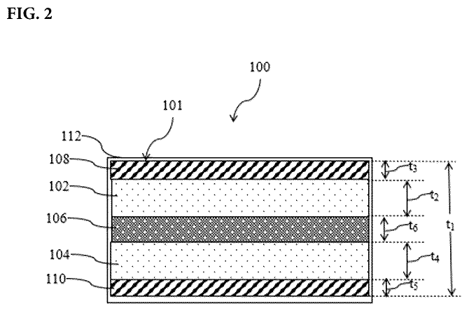

FIG. 1 illustrates a cell 101 of a solid state battery 100 according to an embodiment. The cell 101 includes a cathode electrode 102, an anode electrode 104, and a solid electrolyte layer 106 intermediate the cathode electrode 102 and the anode electrode 104. The cell 101 can optionally include an additional layer or layers, such as, for example, a separator layer, a protective layer, an inhibitor layer, a solid electrolyte interface layer, or a combination thereof.

### Cell Configuration

As illustrated in FIG. 1, the solid state battery 100 may include a single cell 101. In other examples, the solid state battery 100 can include multiple cells, such as, at least two cells, at least three cells, or at least four cells. Connecting the cells in series increases a voltage of the solid state battery 100 and connecting the cells in parallel increases an amp-hour capacity of the solid state battery 100.

### Dimensions of Cell

The cell 101 may have a width, w₁, a length, l₁, and a thickness, t₁.

### Thickness of Cell

A thickness, t₁, of the cell 101 can be at or about any number in a range of from about 100 μm to about 5000 μm, such as about 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400,410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1100, 1200, 1300, 1400, 1500, 1600, 1700, 1800, 1900, 2000, 3000, 4000, 5000 μm, or any other number between any two exemplary numbers listed herein. In some embodiments, the thickness, t₁, of the cell 101 may be within a range formed by selecting any two numbers within the range of from about 100 μm to about 5000 μm, e.g., between about 100 μm and about 5,000 μm or about 100 μm and about 1,000 μm.

### Aspect Ratio of Width

The width, w₁, of the cell 101 may be substantially greater than the thickness, t₁, of the cell 101. In some embodiments, an aspect ratio of the width, w₁, to the thickness, t₁, may be at least 10, at least 20, at least 30, at least 40, at least 50, at least 60, at least 70, at least 80, at least 90, at least 100, at least 110, at least 120, at least 130, at least 140, at least 150, at least 160, at least 170, at least 180, at least 190, at least 200, at least 210, at least 220, at least 230, at least 240, at least 250, at least 260, at least 270, at least 280, at least 290, at least 300, at least 350, at least 400, at least 450, at least 500, at least 550, at least 600, at least 650, at least 700, at least 750, at least 800, at least 850, at least 900, at least 950, at least 1000, at least 2000, at least 3000, at least 4000, at least 5000, at least 6000, at least 7000, at least 8000, at least 9000, or at least 10000.

### Aspect Ratio of Length

The length, l₁, of the cell 101 may be substantially greater than the thickness, t1, of the cell 101. In some embodiments, an aspect ratio of the the length, l₁, to the thickness, t₁, may be at least 10, at least 20, at least 30, at least 40, at least 50, at least 60, at least 70, at least 80, at least 90, at least 100, at least 110, at least 120, at least 130, at least 140, at least 150, at least 160, at least 170, at least 180, at least 190, at least 200, at least 210, at least 220, at least 230, at least 240, at least 250, at least 260, at least 270, at least 280, at least 290, at least 300, at least 350, at least 400, at least 450, at least 500, at least 550, at least 600, at least 650, at least 700, at least 750, at least 800, at least 850, at least 900, at least 950, at least 1000, at least 2000, at least 3000, at least 4000, at least 5000, at least 6000, at least 7000, at least 8000, at least 9000, or at least 10000.

### Cathode Electrode

The cathode electrode 102 is associated with one polarity (e.g., positive) of the solid state battery 100. The cathode electrode 102 is configured as a positive electrode during discharge of the solid state battery 100. The cathode electrode 102 is suitable for lithium ion diffusion between a current collector 108 and the solid electrolyte layer 106. The cathode electrode 102 is in electrical communication with the current collector 108.

### Cathode Electrode Positioning

In embodiments, the cathode electrode 102 is formed over and in direct contact with the current collector 108. In other embodiments, another functional layer may be interposed between the cathode electrode 102 and the current collector 108.

### Materials for Cathode Electrode

The cathode electrode 102 may be capable of reversible intercalation and deintercalation of lithium ions. For example, the cathode electrode 102 can comprise a cathode active material, a conductive carbon, a solid electrolyte material, a binder, the like, or combinations thereof. Optionally, the cathode electrode 102 may further comprise an additive, such as, for example, an oxidation stabilizing agent, a reduction stabilizing agent, a flame retardant, a heat stabilizer, an antifogging agent, a thickener, the like, or a combination thereof.

### Examples of Additives

Examples of these additives may include butylated hydroxyanisole (BHA) or butylated hydroxytoluene (BHT) as oxidation stabilizing agents, ascorbic acid or sodium sulfite as reduction stabilizing agents, aluminum hydroxide or magnesium hydroxide as flame retardants, phenolic compounds or phosphites as heat stabilizers, polyethylene glycol or silica nanoparticles as antifogging agents, and carboxymethyl cellulose (CMC) or xanthan gum as thickeners.

### Cathode Active Material

The cathode active material can include lithium cobalt oxide (LiCoO₂), lithium nickel oxide (LiNiO₂), Li[NiₐCo_{b}Mn_{c}M¹_{d}]O₂ (wherein M¹ is any one element elected from the group consisting of Al, Ga, In, or a combination thereof, 0.3≤a<1.0, 0≤b≤0.5, 0≤c≤0.5, 0≤d≤0.1, and a+b+c+d=1), Li(LiₑM² _{f-e-f}M³_{f′})O_{2-g}A_{g} (wherein 0≤e≤0.2, 0.6≤f≤1, 0≤f′≤0.2, 0≤g≤0.2, M² includes Mn and at least one element selected from the group consisting of Ni, Co, Fe, Cr, V, Cu, Zn and Ti, M³ is at least one element selected from the group consisting of Al, Mg and B, and A is at least one element selected from the group consisting of P, F, S and N), or those compounds substituted with one or more transition metals; lithium manganese oxides such as those represented by the chemical formula of Li^{1+h}Mn₂₋ₕO₄ (wherein 0≤h≤0.33), LiMnO₃, LiMn₂O₃, LiMnO₂, or the like; lithium copper oxide (Li₂CuO₂); vanadium oxides such as LiV₃O₈, V₂O₅ or Cu₂V₂O₇; Ni-site type lithium nickel oxides represented by the chemical formula of LiNi₁₋ᵢM⁴ᵢO₂ (wherein M⁴=Co, Mn, Al, Cu, Fe, Mg, B or Ga, and 0.01≤y≤0.3); lithium manganese composite oxides represented by the chemical formula of LiMn₂₋ⱼM⁵ⱼO₂ (wherein M⁵=Co, Ni, Fe, Cr, Zn, or Ta, and 0.01≤y≤0.1) or Li₂Mn₃M⁶O₈ (wherein M⁶=Fe, Co, Ni, Cu, or Zn); LiMn₂O₄ in which Li is partially substituted with an alkaline earth metal ion; disulfide compounds; LiFe₃O₄, Fe₂(MoO₄)₃; the like; or combinations thereof.

### Phosphate-Based Materials

In addition to the cathode active materials previously mentioned, the cathode electrode may include other types of materials. For example, lithium iron phosphate (LiFePO4) may be used as a cathode active material due to its excellent thermal stability and long cycle life. Other phosphate-based materials such as lithium manganese iron phosphate (LiMnxFe1-xPO4) or lithium cobalt phosphate (LiCoPO4) may also be suitable.

### Layered Oxide Materials

The cathode active material may also include layered oxide materials with various compositions, such as Li(Ni1-x-yCoxMny)O2 (NCM) or Li(Ni1-x-yCoxAly)O2 (NCA), where the ratios of Ni, Co, Mn, and Al can be adjusted to optimize performance characteristics. For instance, NCM materials with high nickel content, such as NCM811 (LiNi0.8Co0.1Mn0.1O2), may be used to achieve higher energy density. In some cases, the cathode active material may comprise spinel structures like LiNi0.5Mn1.5O4, which can offer high voltage operation. Alternatively, materials with tavorite structures, such as LiFeSO4F or LiVPO4F, may be employed for their potential for high energy density and good thermal stability.

### Composite or Blended Cathode Materials

Composite or blended cathode materials, combining two or more active materials, may also be used. For example, a blend of layered oxides and spinel materials might be employed to balance energy density and power capability. As another example, lithium iron phosphate may be blended with one or more of the cathode active materials described above. In some embodiments, the cathode active material may include surface-modified versions of the aforementioned compounds, where the surface modification aims to improve stability, conductivity, or other performance metrics.

### Emerging Classes of Materials

The cathode active material may also include emerging classes of materials such as disordered rock salt structures (e.g., Li3NbO4-based materials) or high-entropy oxides, which may offer desirable combinations of high capacity and structural stability. In some cases, the cathode active material may incorporate dopants or substitutional elements to further tune its electrochemical properties.

### Particulate Nature of Cathode Active Material

The cathode active material can be particle shaped. The cathode active material can have a particle size in a range of from about 1 nm to about 1000 μm, such as about any of 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 550 nm, 600 nm, 650 nm, 700 nm, 750 nm, 800 nm, 850 nm, 900 nm, 950 nm, 1000 nm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, 500 μm, 550 μm, 600 μm, 650 μm, 700 μm, 750 μm, 800 μm, 850 μm, 900 μm, 950 μm, 1,000 μm, or any other number between any two exemplary numbers listed herein. In embodiments, particle size of the cathode active material may be within a range formed by selecting any two numbers in the range of from about 1 nm to about 1000 μm,, e.g., between about 10 nm and about 1,000 μm. Gaps between cathode active material particles in the cathode electrode 102 can be filled with the solid electrolyte material.

### Amount of Cathode Active Material in Cathode Electrode

The amount of the cathode active material in the solid state battery 100 affects the charge and discharge capacity of the solid state battery 100. In order to manufacture a high-capacity cathode electrode 102, a high level of cathode active material can be included in the cathode electrode 102. For example, the cathode electrode 102 includes at, about, or greater than 1, 5, 10, 15, 20, 25, 30, 35, 40, 45, 50, 55, 60, 65, 70, 75, 80, 85, 90, 95, 98, or 99 wt %, or any other number (wt %) between any two numbers (wt %) listed herein of cathode active material based on the total weight of the cathode electrode 102. In embodiments, cathode active material in the cathode electrode 102 may be within a range formed by selecting any two numbers within the range from greater than 0 to about 100 wt %, e.g., between about 40 wt % and about 98 wt %.

### Conductive Material in Cathode Electrode

The conductive material in the cathode electrode 102 is not particularly limited, as long as it has conductivity while not causing any chemical change in the corresponding solid state battery 100. For example, the conductive material can comprise graphite, such as natural graphite or artificial graphite; carbon black, such as acetylene black, ketjen black, channel black, furnace black, lamp black or thermal black; conductive fibers, such as carbon fibers or metal fibers; carbon nanotubes (CNT), including both singled-walled carbon nanotubes (SWCNT) and multi-walled carbon nanotubes (MWCNT); metal powder, such as fluorocarbon, aluminum or nickel powder; conductive whiskers, such as zinc oxide or potassium titanate; conductive metal oxides, such as titanium oxide; conductive polymers, such as polyphenylene derivatives; the like; or combinations thereof.

### Amount of Conductive Material in Cathode Electrode

The cathode electrode 102 includes at or about 1, 3, 4, 5, 6, 7, 8, 9, 10, 11, 12, 13, 14, 15,16, 17, 18, 19, 20, 21, 22, 23, 24, 25, 26, 27, 28, 29, or 30 wt % of conductive material based on the total weight of the cathode electrode 102. In embodiments, conductive material in the cathode electrode 102 may be within a range formed by selecting any two numbers listed in the immediately previous sentence, e.g., between about 1 wt % and about 30 wt %.

### Materials for Binder

The binder can comprise various types of binder polymers, such as, for example, polyvinylidene fluoride-co-hexafluoropropylene (PVdF-co-HFP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylate, ethylene-propylene-diene monomer (EPDM), sulfonated EPDM, styrene butadiene rubber (SBR), fluororubber, polyacrylic acid, polymers thereof whose hydrogen atoms are substituted with Li, Na or Ca, various copolymers thereof, the like, or combinations thereof.

### Other Binder Materials

In addition to the binder materials previously mentioned, other types of binder materials may be used in the cathode electrode to enhance its performance and stability. For instance, water-soluble binders such as sodium alginate, gelatin, or polyacrylamide may be employed to improve the environmental friendliness of the electrode manufacturing process. These binders may also offer advantages in terms of electrode flexibility and adhesion strength. In some cases, conductive binders like poly(3,4-ethylenedioxythiophene): poly(styrene sulfonate) (PEDOT: PSS) or polyaniline (PANI) may be used to simultaneously improve both the mechanical integrity and electrical conductivity of the electrode.

### Novel Binder Systems

Novel binder systems, such as self-healing polymers or supramolecular assemblies, may be incorporated to enhance the long-term stability and cycle life of the battery. Additionally, composite binders combining multiple polymers or incorporating inorganic nanoparticles may be utilized to tailor the mechanical, thermal, and electrochemical properties of the electrode. In some embodiments, bio-derived or biodegradable binders, such as cellulose derivatives or chitosan, may be employed to reduce the environmental impact of battery production and disposal.

### Amount of Binder in the Cathode Electrode

The cathode electrode 102 may include at or about 1, 2, 3, 4, 5, 6, 7, 8, 9, 10, 11, 12, 13, 14, 15,16, 17, 18, 19, 20, 21, 22, 23, 24, 25, 26, 27, 28, 29, or 30 wt % of binder based on the total weight of the cathode electrode 102. In embodiments, binder in the cathode electrode 102 may be within a range formed by selecting any two numbers listed in the immediately previous sentence, e.g., between about 1 wt % and about 30 wt %.

### Solid Electrolyte Material

The solid electrolyte material in the cathode electrode 102 can be configured the same as the material for the solid electrolyte layer 106 discussed below. The solid electrolyte material in the cathode electrode 102 can be the same as or different than the material for the solid electrolyte layer 106.

### Amount of Solid Electrolyte Material in Cathode Electrode

The cathode electrode 102 may include about 1, 2, 3, 4, 5, 6, 7, 8, 9, 10, 11, 12, 13, 14, 15,16, 17, 18, 19, 20, 21, 22, 23, 24, 25, 26, 27, 28, 29, or 30 wt % of solid electrolyte material based on the total weight of the cathode electrode 102. In embodiments, the amount of solid electrolyte material in the cathode electrode 102 may be within a range formed by selecting any two numbers listed in the immediately previous sentence, e.g., between about 1 wt % and about 30 wt %.

### Thickness of Cathode Electrode

A thickness, t₂, of the cathode electrode 102 can be at or about any number in a range of from greater than 0 to 1000 μm, such as 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400,410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1,000 μm, or any other number between any two exemplary numbers listed herein. In embodiments, the thickness, t₂, of the cathode electrode 102 may be within a range formed by selecting any two numbers within the range of from greater than 0 to about 1000 μm, e.g., between about 10 μm and about 1,000 μm.

### Porosity of Cathode Electrode

A porosity of the cathode electrode 102 can be at or about any number in a range of from 0 to 20 vol %, such as 0, 1, 2 3, 4, 5, 6, 7, 8, 9, 10, 11, 12, 13, 14, 15, 16, 17, or 18 vol % or any other vol % within the range of 0 to 20 vol %, based on the total volume of the cathode electrode 102. In embodiments, the porosity of the cathode electrode 102 may be within a range formed by selecting any two numbers within the range of 0 to 20 vol %, e.g., between 0 vol % and about 18 vol %.

### Lithium Ion Diffusivity of Cathode Electrode

The cathode electrode 102 can include a lithium ion diffusivity at or about any number in a range of from greater than 0 to 1×10⁻⁷ cm²/s, such as 1×10⁻¹⁴ cm²/s, 1×10⁻¹³ cm²/s, 1×10⁻¹² cm²/s, 1×10⁻¹¹ cm²/s, 1×10⁻¹⁰ cm²/s, 1×10⁻⁹ cm²/s, 1×10⁻⁸ cm²/s, or 1×10⁻⁷ cm²/s, or any other number within the range of from greater than 0 to 1×10⁻⁷ cm²/s. In embodiments, the lithium ion diffusivity of the cathode electrode 102 may be within a range formed by selecting any two numbers within the range of from greater than 0 to 1×10⁻⁷ cm²/s, e.g., between 1×10⁻¹⁴ cm²/s and about 1×10⁻⁷ cm²/s.

### Current Collector at Cathode Electrode

The current collector 108 collects electrical energy generated at the cathode electrode 102 and supports the cathode electrode 102.

### Materials for Current Collector at Cathode Electrode

The material of the current collector 108 is not particularly limited as long as it allows adhesion of the cathode electrode 102, has a suitable electrical conductivity, and does not cause significant chemical changes in the corresponding solid state battery 100 in the voltage range of the solid state battery 100. For example, the current collector 108 is made of or includes various materials, such as, a metal, a conductive carbon, or a conductive ceramic, although not limited thereto. The metal of the current collector 108 may include one or more selected from the group consisting aluminum, an aluminum alloy, copper, a copper alloy, nickel, a nickel alloy, titanium, a titanium alloy, iron, an iron alloy (e.g., steel, stainless steel), silver, a silver alloy, gold, platinum, palladium, chromium, molybdenum, tungsten, tantalum, niobium, zirconium, vanadium, manganese, cobalt, indium, tin, lead, bismuth, or a combination thereof, although not limited thereto.

### Current Collector Geometry

The current collector 108 may also be configured in various other geometries to optimize its performance and integration with the cathode electrode 102, and may be sized for specific form factors, such as pouch, cylindrical, and/or prismatic form factors.

### Shape of Current Collector at Cathode Electrode

It is possible to increase the adhesion of the cathode electrode 102 to the current collector 108 by forming fine surface irregularities on the surface of the current collector 108. The current collector 108 may have various shapes, such as, for example, a film, a sheet, a foil, a net, a porous body, a foam, a non-woven web, the like, or combinations thereof.

### Examples of Shape and Size of Current Collector

For instance, the current collector 108 may be structured as a mesh or grid, which can provide enhanced mechanical support while maintaining high surface area for electrode adhesion. In some embodiments, the current collector 108 may be designed with a corrugated or wavy pattern, potentially increasing the contact area with the cathode material and improving overall conductivity. The current collector 108 may also be fabricated as a perforated sheet, allowing for better electrolyte penetration and ion transport. In certain cases, the current collector 108 may be formed as a three-dimensional structure, such as an interconnected network of fibers or a honeycomb-like configuration, which could enhance the structural integrity of the electrode assembly while facilitating efficient current collection.

### Thickness of Current Collector at Cathode Electrode

A thickness, t₃, of the current collector 108 can be at or about any number in a range of from greater than 0 to 500 μm, such as 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400,410, 420, 430, 440, 450, 460, 470, 480, 490, 500 μm, or any other number between any two exemplary numbers listed herein. In embodiments, the thickness, t₃, of the current collector 108 may be within a range formed by selecting any two numbers within the range of from greater than 0 to 500 μm, e.g., between about 5 μm and about 500 μm.

### Manufacturing Methods for Cathode Electrode

The cathode electrode 102 may be obtained by various methods.

### Dry Powder Coating Process

For instance, a dry powder coating process may be employed, where the cathode active material, conductive additives, and binder are mixed in a dry state and then directly applied to the current collector 108 using electrostatic deposition or mechanical compression. This method may reduce environmental impact by reducing use of solvents.

### 3D Printing

In some cases, the cathode electrode 102 may be fabricated using additive manufacturing techniques such as 3D printing. This approach allows for precise control over the electrode structure and porosity, potentially enhancing the electrode's performance and energy density. Various 3D printing methods, including fused deposition modeling (FDM), selective laser sintering (SLS), or direct ink writing (DIW), may be utilized depending on the specific materials and desired electrode properties.

### Electrospinning

Another method for manufacturing the cathode electrode 102 may involve electrospinning. In this process, a solution containing the cathode active material, conductive additives, and a polymer binder is extruded through a nozzle under an electric field, resulting in the formation of nanofibers. These fibers can be collected directly on the current collector 108 to form a highly porous electrode structure with increased surface area.

### Tape Casting

In some embodiments, the cathode electrode 102 may be prepared using a tape casting method. This technique involves spreading a slurry of electrode materials onto a moving carrier film using a doctor blade, followed by drying and calendaring. The resulting electrode tape can then be laminated onto the current collector 108.

### Spray Coating

Alternatively, the cathode electrode 102 may be fabricated using a spray coating technique. In this method, a fine mist of the electrode slurry is sprayed onto the current collector 108 using compressed air or ultrasonic atomization. This approach may allow for the creation of thin, uniform electrode layers and can be particularly useful for large-scale production.

### Freeze-Casting

In certain cases, the cathode electrode 102 may be manufactured using a freeze-casting method. This process involves freezing a slurry of electrode materials, followed by sublimation of the ice to create a porous structure. The resulting porous electrode can then be sintered and attached to the current collector 108.

### Sol-Gel Process

For some applications, the cathode electrode 102 may be prepared using a sol-gel process. This method involves the formation of a colloidal suspension (sol) that is then converted into a gel-like network containing the cathode active material and other components. The gel can be applied to the current collector 108 and subsequently heat-treated to form the final electrode structure.

### Slurry-Based Process

For example, the cathode active material can be mixed and agitated with a solvent, and optionally a binder, conductive material, and a dispersing agent to form slurry. Then, the slurry can be applied (e.g., coated) onto the current collector 108, followed by pressing and drying, to obtain the cathode electrode 102.

### Application Methods for Slurry for Cathode Electrode

The application of the slurry to the cathode electrode 102 may include using a technique selected from the group consisting of slot die coating, gravure coating, spin coating, spray coating, roll coating, curtain coating, extrusion, casting, screen printing, inkjet printing, spray printing, gravure printing, heat transfer printing, a Toppan printing method, intaglio printing, offset printing, the like, and combinations thereof.

### Double Layer Slot Die Coating

In some embodiments, the cathode electrode 102 may be fabricated using a double layer slot die coating (DLD) technique. This method involves the simultaneous application of two distinct layers of electrode materials onto the current collector 108 in a single pass. The DLD process may allow for the creation of gradient structures within the electrode, potentially optimizing both the electrochemical performance and mechanical properties of the cathode. Additionally, this technique may enable the incorporation of functional interlayers or protective coatings as part of the electrode manufacturing process, potentially enhancing the overall battery performance and longevity.

### Solvent for Slurry for Cathode Electrode

The solvent for forming the cathode electrode 102 may include water and/or an organic solvents, such as, for example, N-methyl pyrrolidone (NMP), dimethyl formamide (DMF), acetone, dimethyl acetamide, dimethyl sulfoxide (DMSO), isopropyl alcohol, the like, or combinations thereof. The solvent may be used in an amount sufficient to dissolve and disperse the electrode ingredients, such as the cathode active material, binder, and conductive material, considering the slurry coating thickness, production yield, the like, or combinations thereof. Additional solvents that may be used include ethanol, methanol, propanol, butanol, ethyl acetate, methyl ethyl ketone, tetrahydrofuran, diethyl ether, and toluene.

### Solvent-free Methods

In some aspects of the disclosure, the cathode electrode 102 may be prepared using a solvent-free method, such as dry powder processing or melt extrusion, which reduce the use of liquid solvents and may offer environmental and cost benefits.

### Dispersing Agent for Slurry for Cathode Electrode

The dispersing agent forming the cathode electrode 102 may include an aqueous dispersing agent and/or an organic dispersing agent, such as, for example, N-methyl-2-pyrrolidone. Other possible dispersing agents may include polyvinylpyrrolidone (PVP), carboxymethyl cellulose (CMC), sodium dodecyl sulfate (SDS), Triton X-100, polyethylene glycol (PEG), polyacrylic acid (PAA), and various surfactants such as polysorbates or poloxamers.

### Drying Technique for Slurry for Cathode Electrode

The slurry for the cathode electrode 102 may be dried by irradiating heat, electron beams (E-beams), gamma rays, or UV (G, H, I-line), the like, or combinations thereof, to vaporize the solvent. For example, the slurry may be vacuum dried at room temperature. Although the solvent is removed through evaporation by the drying step, the other ingredients do not evaporate and remain as they are to form the cathode electrode 102.

### Additional Drying Techniques

In addition to the drying techniques mentioned, the cathode electrode 102 may be dried using other methods such as infrared (IR) drying, microwave drying, or freeze-drying.

### Combination of Drying Techniques

In some embodiments, a combination of drying techniques may be employed, such as using convection heating followed by vacuum drying, to optimize the drying process and ensure complete solvent removal while maintaining the integrity of the electrode structure.

### Anode Electrode Generally

The anode electrode 104 is associated with one polarity (e.g., negative) of the solid state battery 100, which is different than the polarity of the cathode electrode 102. The anode electrode 104 is configured as a negative electrode during discharge of the solid state battery 100. The anode electrode 104 is suitable for lithium ion diffusion between a current collector 110 and the solid electrolyte layer 106.

### Anode Electrode Positioning

The anode electrode 104 is in electrical communication with the current collector 110. In embodiments, the anode electrode 104 is formed over and in direct contact with the current collector 110. In other embodiments, another functional layer may be interposed between the anode electrode 104 and the current collector 110.

### Anodeless Electrode System

In some embodiments, as explained above, the solid state battery 100 may utilize an anodeless electrode system. In such configurations, the anode electrode 104 may be omitted, and lithium metal may be deposited directly onto the current collector 110 during charging. This approach may potentially increase the energy density of the battery and eliminate a separate anode material, while also potentially reducing the overall thickness of the battery structure.

### Materials for Anode Electrode

The anode electrode 104 may be capable of reversible intercalation and deintercalation of lithium ions. For example, the anode electrode 104 can comprise an anode active material, a binder, the like, or combinations thereof.

### Additives for Anode Electrode

Optionally, the anode electrode 104 may further comprise an additive, such as, for example, an oxidation stabilizing agent (e.g., butylated hydroxyanisole, butylated hydroxytoluene, propyl gallate, tert-butylhydroquinone), a reduction stabilizing agent (e.g., ascorbic acid, sodium sulfite, erythorbic acid, sodium metabisulfite), a flame retardant (e.g., aluminum hydroxide, magnesium hydroxide, ammonium polyphosphate, melamine cyanurate), a heat or light stabilizer (e.g., phenolic compounds, phosphites, hindered amine light stabilizers, UV absorbers like benzophenones or benzotriazoles), an antifogging agent (e.g., polyethylene glycol, silica nanoparticles, glycerol, sorbitol), a thickener (e.g., carboxymethyl cellulose, xanthan gum), the like, or a combination thereof.

### Other Additives for Anode Electrode

Additionally, conductive additives such as carbon black, graphene, or carbon nanotubes may be incorporated to enhance electrical conductivity, while binder modifiers like styrene-butadiene rubber or polyacrylic acid may improve adhesion and mechanical stability. Functional additives such as fluoroethylene carbonate or vinylene carbonate may also be included to promote the formation of a stable solid electrolyte interphase layer on the anode surface.

### Materials for Anode Active Material

The anode active material is made of or includes various materials, such as, for example, an alkali earth metal, an alkaline earth metal, a group 3B metal, a transition metal, a metalloid, an alloy thereof, a conductive carbon, the like, or a combination thereof, although not limited thereof. In embodiments, the anode active material can comprise silicon, a silicon alloy, lithium, a lithium alloy, a conductive carbon, or a combination thereof, although not limited thereto. In embodiments, the lithium alloy is made of or includes a lithium alloy comprising silicon, chlorine, or a combination thereof. A lithium metal thin film may be used as the anode active material.

### Other Materials Anode Active Materials

The anode active material can include carbon-based material such as artificial graphite, natural graphite, graphitized carbon fiber, amorphous carbon or the like; a metallic compound capable of alloying with lithium such as Si, Al, Sn, Pb, Zn, Bi, In, Mg, Ga, Cd, a Si alloy, a Sn alloy, an Al alloy, or the like; a metal oxide capable of doping and dedoping lithium ions such as SiOₓ(0<x<2), SnO₂, vanadium oxide or lithium vanadium oxide; and a composite including the metallic compound and the carbon-based material such as a Si—C composite or a Sn—C composite.

### Carbon-Based Materials

The carbon-based material can include low-crystallinity carbon, high-crystallinity carbon, the like, or combinations thereof. A representative example of low-crystallinity carbon is soft carbon or hard carbon, and a representative example of the high-crystallinity carbon is high-temperature calcined carbon such as amorphous, platy, flaky, spherical or fibrous natural graphite or artificial graphite, kish graphite, pyrolytic carbon, mesophase pitch-based carbon fiber, meso-carbon microbeads, mesophase pitches, petroleum or coal tar pitch-derived coke, the like, or combinations thereof.

### Metal Carbon Composite Materials

Alternatively, according to aspects of the disclosure, the anode electrode 104 may comprise an anode material with a metal carbon composite, such as a silver-carbon blend or composite, where silver particles are complexed between amorphous and/or crystalline carbon particles. While silver is used as exemplary, other metals may be used, including for example, tin, silicon, zinc, or combinations thereof.

### Further Materials for Anode Active Material

In addition to the materials mentioned, the anode active material may also include titanium-based compounds such as lithium titanate (Li4Ti5O12) or titanium dioxide (TiO2), which can offer excellent cycling stability and high-rate capability. Other potential materials may include transition metal oxides like molybdenum oxides (MoOx), iron oxides (FeOx), or nickel oxides (NiOx), which can provide high theoretical capacities. In some cases, composite materials combining different active materials, such as silicon-graphite composites or tin-carbon composites, may be used to leverage the advantages of multiple materials while mitigating their individual limitations.

### Dendrite Formation

When the anode electrode 104 is made of or includes lithium or a lithium alloy, dendrites may form on the anode electrode 104. The dendrites are a metallic lithium structure formed when extra lithium ions accumulate on a surface of the anode electrode 104. The formed dendrites may damage the solid electrolyte layer 106, reduce battery capacity of the solid state battery 100, and/or otherwise lead to undesired performance of the solid state battery 100. Dendrite formation is a significant challenge in lithium-based batteries, as these structures can grow through the electrolyte, potentially causing short circuits and safety hazards. The growth rate and morphology of dendrites may be influenced by factors such as current density, temperature, and the nature of the electrolyte-electrode interface.

### Advantages of Solid Electrolytes in Mitigating Dendrite Formation

Solid electrolytes offer several advantages over liquid electrolytes when it comes to mitigating dendrite formation. The mechanical strength of solid electrolytes may help suppress dendrite growth by providing a physical barrier to lithium metal penetration. Additionally, the uniform ion distribution in solid electrolytes may promote more even lithium deposition, reducing the likelihood of localized dendrite nucleation. Some solid electrolytes may also form a stable interface with the lithium metal anode, further inhibiting dendrite formation. However, while solid electrolytes can significantly reduce the risk of dendrite growth, they may not completely eliminate it, and ongoing research aims to develop advanced solid electrolyte materials with enhanced dendrite suppression capabilities.

### Shape of Anode Active Material

The anode active material can be particle shaped or it may be a continuous, unitary form (e.g., a thin film or sheet).

### Particle Size

In embodiments where the anode active material is particle shaped, the anode active material can comprise a particle size of any number in a range from at or about 10 nm to at or about 1000 μm, such as at or about 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940nm, 950 nm, 960 nm, 970 nm, 980 nm, 990 nm, 1000 nm, 2 μm, 3 μm, 4 μm, 5 μm, 6 μm, 7 μm, 8 μm, 9 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, 500 μm, 510 μm, 520 μm, 530 μm, 540 μm, 550 μm, 560 μm, 570 μm, 580 μm, 590 μm, 600 μm, 610 μm, 620 μm, 630 μm, 640 μm, 650 μm, 660 μm, 670 μm, 680 μm, 690 μm, 700 μm, 710 μm, 720 μm, 730 μm, 740 μm, 750 μm, 760 μm, 770 μm, 780 μm, 790 μm, 800 μm, 810 μm, 820 μm, 830 μm, 840 μm, 850 μm, 860 μm, 870 μm, 880 μm, 890 μm, 900 μm, 910 μm, 920 μm, 930 μm, 940 μm, 950 μm, 960 μm, 970 μm, 980 μm, 990 μm, or 1,000 μm, or any other number within the range from about 10 nm to about 1000 μm. In embodiments, particle size of the anode active material may be within a range formed by selecting any two numbers in the range of from at or about 10 nm to at or about 1000 μm, e.g., between about 10 nm and about 1,000 μm.

### Amount of Anode Active Material in Anode Electrode

The amount of the anode active material in the solid state battery 100 affects the charge and discharge capacity of the solid state battery 100. In order to manufacture a high-capacity anode electrode 104, a high level of anode active material can be included in the anode electrode 104. For example, the anode electrode 104 includes at, about, or greater than 70, 80, 90, 95, 98, 99, or 100 wt % of anode active material based on the total weight of the anode electrode 104. In embodiments, anode active material in the anode electrode 104 may be within a range formed by selecting any two numbers listed in the immediately previous sentence, e.g., between about 70 wt % and about 100 wt %.

### Materials for Binder in Anode Electrode

The binder can comprise various types of binder polymers, such as, for example, polyvinylidene fluoride-co-hexafluoropropylene (PVdF-co-HFP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylate, ethylene-propylene-diene monomer (EPDM), sulfonated EPDM, styrene butadiene rubber (SBR), fluororubber, polyacrylic acid, polymers thereof whose hydrogen atoms are substituted with Li, Na or Ca, various copolymers thereof, the like, or combinations thereof.

### Examples of Materials for Binder in Anode Electrode

In addition to the binders mentioned, other suitable binders for use in the anode electrode may include polyimide, polyamide-imide, polyurethane, polyethylene oxide (PEO), poly(ethylene-co-vinyl acetate) (PEVA), poly(vinyl acetate) (PVA), alginate, chitosan, guar gum, xanthan gum, carrageenan, pectin, gelatin, lignin, and various water-soluble polymers or their derivatives. In some cases, conductive polymers such as polypyrrole, polyaniline, or poly(3,4-ethylenedioxythiophene) (PEDOT) may also be used as binders to simultaneously improve adhesion and electrical conductivity within the anode electrode.

### Amount of Binder in Anode Electrode

The anode electrode 104 may include at or about 0, 1, 2, 3, 4, 5, 6, 7, 8, 9, 10, 11, 12, 13, 14, 15, 17, 18, 19, 20, 21, 22, 23, 24, 25, 26, 27, 28, 29, or 30 wt %, or any other wt % in the range between 0 and 30 wt % of binder based on the total weight of the anode electrode 104. In embodiments, binder in the anode electrode 104 may be within a range formed by selecting any two numbers in the range between 0 and 30 wt %, e.g., between about 0 wt % and about 30 wt %.

### Thickness of Anode Electrode

The anode electrode 104 can have a thickness of at or about 10, 15, 20, 25, 30, 35, 40,45, 50, 55, 60, 65, 70, 75, 80, 85, 90, 95, or 100 μm, or any other number between about 10 μm and about 100 μm. In embodiments, the thickness, t₄, of the anode electrode 104 may be within a range formed by selecting any two numbers in the range of from 10 μm to about 100 μm, e.g., between about 10 μm and about 100 μm or about 10 μm and about 20 μm.

### Porosity of Anode Electrode

A porosity of the anode electrode 104 can be about 0, 1, 2, 3, 4, 5, 6, 7, 8, 9, 10, 11, 12, 13, 14, 15, 16, 17, or 18 vol %, or any other vol % in the range from 0 to 18 vol %, based on the total volume of the anode electrode 104. In embodiments, the porosity of the anode electrode 104 may be within a range formed by selecting any two numbers in the range from between 0 vol % to about 18 vol %.

### Lithium Ion Diffusivity of Anode Electrode.

The anode electrode 104 may include a lithium ion diffusivity of at or about 1×10⁻¹⁴ cm²/s, 1×10⁻¹³ cm²/s, 1×10⁻¹² cm²/s, 1×10⁻¹¹ cm²/s, 1×10⁻¹⁰ cm²/s, 1×10⁻⁹ cm²/s, 1×10⁻⁸ cm²/s, or 1×10⁻⁷ cm²/s, or any other number between at or about 1×10⁻¹⁴ cm²/s and at or about 1×10⁻⁷ cm²/s. In embodiments, the lithium ion diffusivity of the anode electrode 104 may be within a range formed by selecting any two numbers in the range from at or about 1×10⁻¹⁴ cm²/s to at or about 1×10⁻⁷ cm²/s.

### Current Collector at Anode Electrode

The current collector 110 collects electrical energy generated at the anode electrode 104 and supports the anode electrode 104.

### Materials for Current Collector at Anode Electrode

The material of the current collector 110 is not particularly limited as long as it allows adhesion of the anode electrode 104, has a suitable electrical conductivity, and does not cause significant chemical changes in the corresponding solid state battery 100 in the voltage range of the solid state battery 100. For example, the current collector 110 is made of or includes a metal or a conductive carbon, although not limited thereto.

### Metal for Current Collector

The metal of the current collector 110 may include one or more selected from the group consisting aluminum, an aluminum alloy, copper, a copper alloy, nickel, a nickel alloy, titanium, a titanium alloy, iron, an iron alloy (e.g., steel, stainless steel), silver, a silver alloy, or a combination thereof, although not limited thereto.

### Shape of Current Collector at Anode Electrode

It is possible to increase the adhesion of the anode electrode 104 to the current collector 110 by forming fine surface irregularities on the surface of the current collector 110. The current collector 110 may have various shapes, such as, for example, a film, a sheet, a foil, a net, a porous body, a foam, a non-woven web body, the like, or combinations thereof. In addition to the shapes mentioned, the current collector 110 may also be configured as a honeycomb structure, a perforated sheet, a woven or non-woven mesh, a sintered porous body, or a three-dimensional interconnected network. These various shapes can be tailored to optimize the surface area, mechanical strength, and current collection efficiency of the current collector 110.

### Design of Current Collector at Anode Electrode

Furthermore, the current collector 110 may be designed to accommodate different form factors of solid state batteries, such as pouch cells, cylindrical cells, or prismatic cells, each may offer advantages in terms of packaging efficiency, thermal management, and overall battery performance.

### Thickness of Current Collector at Anode Electrode

A thickness, t₅, of the current collector 110 can be at or about 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or 500 μm, or any other number in the range of from at or about 1 μm to at or about 500 μm. In embodiments, the thickness, t₅, of the current collector 110 may be within a range formed by selecting any two numbers listed in the range of from at or about 1 μm to at or about 500 μm, e.g., between about 5 μm and about 500 μm.

### Manufacturing Methods for Anode Electrode

The anode electrode 104 may be obtained by various methods, such as, for example, atomic deposition, extrusion, rolling, a slurry method, or a combination thereof. In addition to the methods mentioned, the anode electrode 104 may be manufactured using various other techniques, including dry electrode processes. These alternative methods may offer advantages in terms of environmental impact, cost-effectiveness, and scalability.

### Dry Powder Coating

Dry powder coating may be employed as an alternative to the slurry method. In this process, the anode active material, conductive additives, and binder are mixed in a dry state and then directly applied to the current collector 110 using electrostatic deposition or mechanical compression. This method may reduce the use of solvents, potentially reducing environmental impact and processing time.

### 3D Printing

Additive manufacturing techniques, such as 3D printing, may be used to fabricate the anode electrode 104. Various 3D printing methods, including fused deposition modeling (FDM), selective laser sintering (SLS), or direct ink writing (DIW), can be utilized depending on the specific materials and desired electrode properties. This approach allows for precise control over the electrode structure and porosity.

### Electrospinning

Electrospinning is another potential method for manufacturing the anode electrode 104. In this process, a solution containing the anode active material, conductive additives, and a polymer binder is extruded through a nozzle under an electric field, resulting in the formation of nanofibers. These fibers can be collected directly on the current collector 110 to form a highly porous electrode structure with increased surface area.

### Tape Casting

Tape casting may be employed to prepare the anode electrode 104. This technique involves spreading a slurry of electrode materials onto a moving carrier film using a doctor blade, followed by drying and calendaring. The resulting electrode tape can then be laminated onto the current collector 110.

### Spray Coating

Spray coating techniques may be used to fabricate the anode electrode 104. A fine mist of the electrode slurry is sprayed onto the current collector 110 using compressed air or ultrasonic atomization. This approach may allow for the creation of thin, uniform electrode layers and can be particularly useful for large-scale production.

### Freeze-Casting

Freeze-casting is another potential method for manufacturing the anode electrode 104. This process involves freezing a slurry of electrode materials, followed by sublimation of the ice to create a porous structure. The resulting porous electrode can then be sintered and attached to the current collector 110.

### Sol-Gel Process

In some cases, a sol-gel process may be used to prepare the anode electrode 104. This method involves the formation of a colloidal suspension (sol) that is then converted into a gel-like network containing the anode active material and other components. The gel can be applied to the current collector 110 and subsequently heat-treated to form the final electrode structure.

### Vapor Deposition

For certain applications, physical vapor deposition (PVD) or chemical vapor deposition (CVD) techniques may be employed to create thin film anodes directly on the current collector 110. These methods can produce highly uniform and dense electrode layers, which may be particularly beneficial for certain types of solid-state batteries.

### Alloying and Ball Milling

Mechanical alloying and high-energy ball milling may be used to prepare composite anode materials, which can then be pressed into electrodes or applied to the current collector 110 using one of the aforementioned methods. This technique can be particularly useful for creating nanostructured or amorphous anode materials with enhanced electrochemical properties.

### Slurry Method

For example, the anode active material can be mixed and agitated with a solvent, and optionally a binder, and a dispersing agent to form slurry. Then, the slurry can be applied (e.g., coated) onto the current collector 110, followed by pressing and drying, to obtain the anode electrode 104.

### Application Methods for Slurry for Anode Electrode

The application of the slurry for the anode electrode 104 may include using a technique selected from the group consisting of slot die coating, gravure coating, spin coating, spray coating, roll coating, curtain coating, extrusion, casting, screen printing, inkjet printing,, spray printing, gravure printing, heat transfer printing, a Toppan printing method, intaglio printing, offset printing, the like, and combinations thereof. In addition to the aforementioned techniques, other methods for applying the anode slurry to the current collector may include doctor blade coating, dip coating, and meniscus coating.

### Double Slot Die Layer Coating

Double slot die layer coating may also be employed, which allows for the simultaneous application of two distinct layers of electrode materials onto the current collector in a single pass. This method can potentially enable the creation of gradient structures within the electrode, optimizing both electrochemical performance and mechanical properties.

### Solvent for Slurry for Anode Electrode

The solvent for forming the anode electrode 104 may include water and/or an organic solvents, such as, for example, N-methyl pyrrolidone (NMP), dimethyl formamide (DMF), acetone, dimethyl acetamide, dimethyl sulfoxide (DMSO), isopropyl alcohol, the like, or combinations thereof. The solvent may be used in an amount sufficient to dissolve and disperse the electrode ingredients, such as the anode active material and binder, considering the slurry coating thickness, production yield, the like, or combinations thereof. Additional organic solvents that may be used include ethanol, methanol, propanol, butanol, ethyl acetate, methyl ethyl ketone, tetrahydrofuran, diethyl ether, and toluene.

### Solvent-Free Methods

In some embodiments, the anode electrode 104 may be prepared using a solvent-free method, such as dry powder processing or melt extrusion, which eliminates the need for liquid solvents and may offer environmental and cost benefits.

### Dispersing Agent for Slurry for Anode Electrode

The dispersing agent forming the anode electrode 104 may include an aqueous dispersing agent and/or an organic dispersing agent, such as, for example, N-methyl-2-pyrrolidone. Other examples of aqueous dispersing agents may include sodium dodecyl sulfate (SDS), polyvinylpyrrolidone (PVP), and carboxymethyl cellulose (CMC), while additional organic dispersing agents may include Triton X-100, polyethylene glycol (PEG), and various surfactants such as polysorbates or poloxamers.

### Methods Without a Dispersing Agent

In some embodiments, the anode electrode 104 may be prepared using methods that do not require a dispersing agent, such as dry powder processing or certain additive manufacturing techniques.

### Drying Technique for Slurry for Anode Electrode

The slurry for the anode electrode 104 may be dried by irradiating heat, electron beams (E-beams), gamma rays, or UV (G, H, I-line), the like, or combinations thereof, to vaporize the solvent. For example, the slurry may be vacuum dried at room temperature. Although the solvent is removed through evaporation by the drying step, the other ingredients do not evaporate and remain as they are to form the anode electrode 104.

### Other Drying Techniques

In addition to the drying techniques mentioned, several other methods may be employed to dry the anode electrode slurry. These additional techniques can offer various advantages depending on the specific materials, production requirements, and desired electrode properties.

### Infrared (IR) Drying

Infrared (IR) drying may be used to rapidly heat the electrode surface, promoting efficient solvent evaporation. This method can be particularly effective for thin electrode coatings and may allow for precise control of the drying process.

### Microwave Drying

Microwave drying is another option that can provide volumetric heating of the electrode material, potentially leading to more uniform drying throughout the electrode thickness. In some cases, a combination of convection and microwave drying may be employed to optimize both drying speed and uniformity.

### Freeze-Drying

Freeze-drying, also known as lyophilization, may be utilized for certain electrode formulations. This process involves freezing the slurry and then sublimating the solvent under vacuum conditions. Freeze-drying can help maintain the porous structure of the electrode, which may be beneficial for electrolyte penetration and ion transport.

### Supercritical CO2 Drying

Supercritical CO₂ drying is an advanced technique that may be employed for specialized electrode materials. This method involves replacing the solvent with liquid CO₂, which is then brought to its supercritical state and vented. This approach can help preserve delicate nanostructures within the electrode and may be particularly useful for aerogel-based electrodes.

### Two-Step Drying

In some cases, a two-step drying process may be employed. For example, initial drying may be performed at a lower temperature to remove bulk solvent, followed by a higher temperature step to remove residual solvent and potentially initiate any desired chemical reactions within the electrode material.

### Ultrasonic Drying

Ultrasonic drying may also be considered for certain electrode formulations. This technique uses high-frequency sound waves to agitate the solvent molecules, potentially accelerating the drying process and improving solvent removal from porous structures within the electrode.

### Solid Electrolyte Layer Generally

The solid electrolyte layer 106 is suitable for lithium ion diffusion between the cathode electrode 102 and the anode electrode 104. The solid electrolyte layer 106 provides an electrically conductive pathway for the movement of charge carriers between the cathode electrode 102 and the anode electrode 104. The solid electrolyte layer 106 is in electrical communication with the cathode electrode 102 and the anode electrode 104.

### Solid Electrolyte Positioning

In embodiments, the solid electrolyte layer 106 is formed over and in direct contact with the cathode electrode 102 or the anode electrode 104. In embodiments, the solid electrolyte layer 106 is in direct contact with the cathode electrode 102 and the anode electrode 104. In other embodiments, another functional layer may be interposed between the solid electrolyte layer 106 and the cathode electrode 102 and/or the anode electrode 104.

### Materials for Solid Electrolyte Layer

The solid electrolyte layer 106 may be capable of transport of lithium ions. The material of the solid electrolyte layer 106 is not particularly limited as long as it allows adhesion with adjacent layers, has a suitable electrical conductivity, and does not cause significant chemical changes in the corresponding solid state battery 100 in the voltage range of the solid state battery 100. For example, the solid electrolyte layer 106 may include various inorganic solid electrolytes, polymer solid electrolytes, and/or polymer gel electrolytes, although not limited thereto. Additionally or alternatively, the solid electrolyte layer 106 may include ceramic electrolytes, glass electrolytes, hybrid organic-inorganic electrolytes, and nanostructured electrolytes, although not limited to these categories.

### Inorganic Solid Electrolyte

The inorganic solid electrolyte may include a crystalline solid electrolyte, a non-crystalline solid electrolyte, a glass ceramic solid electrolyte, the like, or a combination thereof, although not limited thereto. The inorganic solid electrolyte may be sulfide-based, oxide-based, the like, or a combination thereof. In addition to sulfide-based and oxide-based inorganic solid electrolytes, other types of inorganic solid electrolytes may include halide-based electrolytes, nitride-based electrolytes, and borate-based electrolytes. For example, lithium-rich anti-perovskites (LiRAP) such as Li3OCl and Li3OBr, lithium nitride (Li3N), and lithium borohydride (LiBH4) have been investigated as potential solid electrolyte materials for lithium-ion batteries.

### Sulfide Based Solid Electrolyte

The sulfide-based solid electrolyte includes sulfur(S) and has ionic conductivity of metal belonging to Group I or Group II of the periodic table, and may include Li—P—S-based glass or Li—P—S-based glass ceramics.

### Examples of Sulfide-Based Solid Electrolyte

For example, the sulfide-based solid electrolyte may include lithium sulfide, silicon sulfide, germanium sulfide and boron sulfide. Particular examples of the inorganic solid electrolyte may include Li_{3.833}Sn_{0.833}As_{0.166}S₄, Li₄SnS₄, Li_{3.25}Ge_{0.25}P_{0.75}S₄, Li₂S—P₂S₀, B₂S₃—Li₂S, XLi₂S-(100−x)P₂S₅ (x=70-80), Li₂S—SiS₂—Li₃N, Li₂S—P₂S₅—LiI, Li₂S—SiS₂—LiI, Li₂S—B₂S₃—LiI, Li₃N, LISICON, LIPON (Li_{3+y}PO₄₋ₓNₓ), thio-LISICON (Li_{3.25}Ge_{0.25}P_{0.75}S₄), Li₂O—Al₂O₃—TiO₂—P₂O₅ (LATP), Li₂S—P₂S₅, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, Li₂S—GeS₂—ZnS, Li10GeP2S12 (LGPS), Li7P3S11, Li6PS5Cl, Li6PS5Br, Li6PS5I, Li9.54Si1.74P1.44S11.7Cl0.3, Li11Si2PS12, the like, or combinations thereof.

### Doped Variants

In some cases, doped variants of these materials, such as Al-doped Li10GeP2S12 or Sb-doped Li6PS5Cl, may also be employed to further enhance ionic conductivity or stability.

### Oxide Based Solid Electrolyte

The oxide-based solid electrolyte material contains oxygen (O) and has ionic conductivity of metal belonging to Group I or II of the periodic table.

### Examples of Oxide-based Solid Electrolyte Material

The oxide-based solid electrolyte material may include at least one selected from the group consisting of LLTO-based compounds, Li₆La₂CaTa₂O₁₂, Li₆La₂ANb₂O₁₂ (A is Ca or Sr), Li₂Nd₃TeSbO₁₂, Li₃BO_{2.5}N_{0.5}, Li₉SiA₁O₈, LAGP-based compounds, LATP-based compounds, Li₁₊ₓTi₂₋ₓAlₓSi_{y}(PO₄)_{3-y} (0≤x≤1, 0≤y≤1), LiAlₓZr₂₋ₓ (PO₄)₃ (0≤x≤1, 0≤y≤1), LiTiₓZr₂₋ₓ(PO₄)₃ (0≤x≤1, 0≤y≤1), LISICON-based compounds, LIPON-based compounds, perovskite-based compounds, NASICON-based compounds and LLZO-based or derived compounds (such as Al-doped Li7La3Zr2O12 and Ta-doped Li7La3Zr2O12). Lithium-rich anti-perovskites like Li3OCl and Li3OBr have also been investigated as potential oxide-based solid electrolytes.

### Composite Oxide Electrolyte

In some cases, composite oxide electrolytes combining multiple oxide materials, such as LLZO-LATP composites, may be employed to leverage the advantages of different oxide systems.

### Polymer Solid Electrolyte

The polymer solid electrolyte is a composite of electrolyte salt with polymer resin and has lithium ion conductivity. The polymer solid electrolyte may include a polyether polymer, a polycarbonate polymer, an acrylate polymer, a polysiloxane polymer, a phosphazene polymer, a polyethylene derivative, an alkylene oxide derivative, a phosphate polymer, a polyagitation lysine, a polyester sulfide, a polyvinyl alcohol, a polyvinylidene fluoride, a polymer containing an ionically dissociable group, poly(ethylene imine) (PEI), poly(methyl methacrylate) (PMMA), poly(acrylonitrile) (PAN), poly(ethylene succinate) (PES), biopolymers such as chitosan and cellulose derivatives, the like, or combinations thereof.

### Polymer Resin for the solid polymer electrolyte

The solid polymer electrolyte may include a polymer resin, such as a branched copolymer including polyethylene oxide (PEO) backbone copolymerized with a comonomer including an amorphous polymer, such as, for example, PMMA, polycarbonate, polydiloxane (pdms) and/or phosphazene, comb-like polymer, crosslinked polymer resin, polyethylene glycol (PEG), polypropylene oxide (PPO), polyacrylonitrile (PAN), poly(methyl methacrylate) (PMMA), poly(vinylidene fluoride-co-hexafluoropropylene) (PVDF-HFP), poly(ethylene oxide-co-propylene oxide) (PEO-PPO), poly(ethylene imine) (PEI), poly(vinyl pyrrolidone) (PVP), poly(vinyl alcohol) (PVA), various block copolymers or graft copolymers incorporating these materials, the like, or combinations thereof.

### Polymer Gel Electrolyte

The polymer gel electrolyte can be formed by incorporating an organic electrolyte containing an organic solvent and an electrolyte salt, an ionic liquid, monomer, or oligomer to a polymer resin, the like, or combinations thereof. The polymer resin for the polymer gel can include polyether polymers, PVC polymers, PMMA polymers, polyacrylonitrile (PAN), polyvinylidene fluoride (PVDF), poly(vinylidene fluoride-co-hexafluoropropylene: PVDF-co-HFP), the like, or combinations thereof.

### Examples of Polymer Gel Electrolyte

Examples of polymer gel electrolytes that may be suitable for solid state batteries include poly(ethylene oxide) (PEO), poly(methyl methacrylate-co-ethyl acrylate) (PMMA-EA), poly(acrylonitrile-co-methyl methacrylate) (PAN-MMA), poly(vinyl acetate) (PVAc), poly(ethylene glycol diacrylate) (PEGDA), poly(vinyl pyrrolidone) (PVP), poly(ethylene glycol methyl ether acrylate) (PEGMEA), poly(ethylene glycol methyl ether methacrylate) (PEGMEMA), poly(ionic liquid) (PIL), poly(ethylene glycol-co-propylene glycol) (PEG-PPG), poly(vinyl alcohol-co-ethylene) (PVA-PE), poly(acrylamide) (PAM), poly(2-hydroxyethyl methacrylate) (PHEMA), poly(ethylene glycol-co-polyethylene oxide) (PEG-PEO), and poly(methacrylic acid) (PMAA) based gel electrolytes to optimize the electrochemical and physical properties of the solid electrolyte.

### Electrolyte Salt

The electrolyte salt is an ionizable lithium salt and may be represented by Li⁺X⁻. X⁻ may include an anion selected from the group consisting of F⁻, Cl⁻, Br⁻, NO₃ ⁻, N(CN)₂ ⁻, BF₄ ⁻, ClO₄ ⁻, AlO₄ ⁻, AlCl₄ ⁻, PF₆ ⁻, SbF₆ ⁻, AsF₆ ⁻, BF₂C₂O₄ ⁻, BC₄O₈ ⁻, (CF₃)₂PF₄ ⁻, (CF₃)₃PF₃⁻, (CF₃)₄PF₂ ⁻, (CF₃)₅PF⁻, (CF₃)₆P⁻, CF₃SO₃ ⁻, C₄F₉SO₃ ⁻, CF₃CF₂SO₃ ⁻, (CF₃SO₂)₂N⁻, (F₂SO₂)₂N⁻, CF₃CF₂(CF₃)₂CO⁻, (CF₃SO₂)₂CH, CF₃(CF₂)₇SO₃ ⁻, CF₃CO₂ ⁻, CH₃CO₂ ⁻, SCN⁻, (CF₃CF₂SO₂)₂N⁻, and the like.

### Examples of Lithium Salt

For example, the lithium salt may be any one selected from the group consisting of LiTFSI, LiCl, LiBr, LiI, LiClO₄, lithium tetrafluoroborate (LiBF₄), LiB₁₀Cl₁₀, lithium hexafluorophosphate (LiPF₆), LiAsF₆, LiSbF₆, LiAlCl₄, LiSCN, LiCF₃CO₂, LiCH₃SO₃, LiCF₃SO₃, LiN(SO₂CF₃)₂, LiN(SO₂C₂F₅)₂, LiC₄F₉SO₃, LiC(CF₃SO₂)₃, (CF₃SO₂) ₂NLi, lithium chloroborate, lithium lower aliphatic carboxylate, lithium imide 4-phenylborate, lithium bis(oxalato)borate (LiBOB), lithium difluoro(oxalato)borate (LiDFOB), lithium bis(fluorosulfonyl)imide (LiFSI), lithium 4,5-dicyano-2-(trifluoromethyl)imidazolide (LiTDI), lithium bis(trifluoromethanesulfonyl)imide (LiTFSI), and lithium bis(fluorosulfonyl)imide (LiFSI), the like, and combinations thereof. The electrolyte salt can include any combination of the salts described herein.

### Amount of Electrolyte Salt

The solid electrolyte layer 106 can include at or about 0, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, or 400 parts, or any other number between 0 and 400 parts, of electrolyte salt, if present, based on the total weight of the solid electrolyte layer 106. In embodiments, electrolyte salt in the solid electrolyte layer 106 may be within a range formed by selecting any two numbers between about 0 parts and about 400 parts, or about 60 parts and 400 parts, based on the total weight of the solid electrolyte layer 106.

### Ion Conductivity of Solid Electrolyte Layer

The solid electrolyte layer 106 may have a suitable reduction stability and/or ion conductivity. Since the solid electrolyte layer 106 mainly functions to transport lithium ions between electrodes, the solid electrolyte layer 106 can include a desirable ion conductivity of at, about, or greater than, for example, 10⁻⁷ S/cm, 10⁻⁶ S/cm, 10⁻⁵ S/cm, or 10⁻⁴ S/cm, or any other number greater than about 10⁻⁷ S/cm.

### Thickness of Solid Electrolyte Layer

A thickness, t₆, of the solid electrolyte layer 106 can be at or about 1, 2, 3, 4, 5, 6, 7, 8, 9, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850,860, 870, 880, 890, 900, 910, 920, 930, 940, 950, 960, 970, 980, 990, or 1,000 μm, or any other number between 0 and at or about 1,000 μm. In embodiments, the thickness, t₆, of the solid electrolyte layer 106 may be within a range formed by selecting any two numbers in the range of between 0 and at or about 1,000 μm, e.g., between about 5 μm and about 1,000 μm, about 30 μm and about 100 μm, or about 30 μm and about 50 μm.

### Unfinished Product

The cell 101 as shown in FIG. 1 can be provided as an unfinished product. In embodiments, the cell 101 is stored, transported, and/or delivered to a reseller, customer, or the like that finishes manufacture of a battery assembly or product comprising the cell 101. In other embodiments, the cell 101 is a finished battery assembly or product.

### Sealing Battery

An enclosure 112 of the solid state battery can be sealed to finish making the solid state battery 100 such that it will work as a battery. The sealing process may involve various techniques to ensure the internal components are protected from external environmental factors and to maintain the integrity of the battery structure. For example, the enclosure 112 may be hermetically sealed using methods such as laser welding, ultrasonic welding, or adhesive bonding. In some cases, the sealing process may also include the introduction of a protective atmosphere or the removal of air to create a vacuum within the enclosure. This sealing step may be helpful for preventing moisture ingress, which could potentially degrade the performance of the sulfide-based solid electrolyte. Additionally, the sealing process may incorporate safety features such as pressure relief mechanisms to manage any potential gas build-up during battery operation.

### After Sealing Battery

Once properly sealed, the solid state battery 100 is ready for final quality control checks, which may include electrical testing, leak detection, and visual inspections. After passing these checks, the solid state battery 100 could be packaged and sold as a finished product, ready for integration into various electronic devices, electric vehicles, energy storage systems, and so forth.

### Battery Configuration

The solid state battery 100 is provided in various configurations to suit different applications and device requirements. In some aspects, the battery may be manufactured in a cylindrical form, which can be advantageous for certain types of portable electronics or automotive applications. Alternatively, the solid state battery 100 may be produced in a prismatic form, which can allow for more efficient space utilization in devices with rectangular form factors. In other cases, a pouch form may be employed, offering flexibility in shape and potentially reducing overall battery weight. The pouch form may further be especially suitable for solid state batteries due to easier application and control of uniform pressures within the battery.

### Choice of Configuration

The choice of configuration may depend on factors such as the intended use, space constraints, thermal management requirements, and manufacturing considerations. In some embodiments, hybrid or custom configurations combining elements of different forms may be utilized as desired. The versatility in battery form factors can enable the integration of solid state batteries into a wide range of products, from small wearable devices to large-scale energy storage systems.

### Voltage

The solid state battery 100 is configured to output a voltage of at or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 48, 50, 55, 60, 65, 70, 75, 80, 85, 90, 95, 96, 100, 110, 120, 130, 140, 150, 160, 170, 180, 190, 200, 210, 220, 230, 240, 250, 260, 270, 280, 290, 300, 310, 320, 330, 340, 350, 360, 370. 380, 390, 400, 410, 420, 430, 440, 450, 460, 470, 480, 490, or 500 V, or any other number between 0 and at or about 500 V DC. In embodiments, the output voltage of the solid state battery 100 may be within a range formed by selecting any two numbers in the range of between 0 and at or about 500 V, e.g., between about 1 V DC and about 500 V DC.

### Capacity

The solid state battery 100 ay be configured to have a capacity of at, about, or greater than 100, 110, 120, 130, 140, 150, 160, 170, 180, 190, 200, 210, 220, 230, 240, 250, 260, 270, 280, 290, or 300 mAh/g, or any other number between 0 and 300 mAh/g or between 0 and about 300 mAh/g. In embodiments, the output voltage of the solid state battery 100 may have a capacity formed by selecting any two numbers in the range of between 0 and 300 mAh/g or between 0 and about 300 mAh/g, e.g., between about 100 mAh/g and about 300 mAh/g.

### Volume Expansion Calculation

The solid state battery 100 may be configured to have a desirable volume expansion rate. The volume expansion rate may be calculated from a change in thickness after the first cycle of charging and discharging compared to the initial thickness. The volume expansion rate may be a ratio of the thickness change to the initial thickness. A first cycle of charging and discharging is performed by CC-CV charging a battery at 0.1 C and cutting off at 4.25 to 4.4 V and 0.02 C, and CC discharging the battery at 0.1 C and cutting off at 3 V. The volume expansion rate is calculated by Equation 1 below in which A may represent a thickness before charging and discharging and B may represent a thickness after charging and discharging. The thickness may be measured using a Mauser micrometer or a scanning electron microscope (SEM).

Volume expansion rate=[(B−A)/A]×100 Equation 1

### C-Rate

C-rate as used herein refers to the rate at which the battery is discharged relative to its maximum capacity. For example, a 1 C rate means the discharge current will discharge the entire battery within one hour. That is, for a battery with a capacity of 20 Amp-hrs, a discharge current at a 1 C would be 20 Amps.

### Other Examples for Volumetric Expansion

Other exemplary ways to measure and calculate the volume expansion rate for a solid state battery may include using volumetric expansion measurement (e.g., gas pycnometry), in-situ dilatometry, X-ray tomography, strain gauge measurements, optical methods (e.g., digital image correlation or laser interferometry), pressure-based methods, and electrochemical strain microscopy.

### EXAMPLES

Examples will be described more fully hereinafter so that the present disclosure can be understood with ease. However, the following examples are for illustrative purposes only and the scope of the present disclosure is not limited thereto.

### EXAMPLE 1: ISOPROPYL SULFIDE

### Example 1.1: Preparing SE Material Using Isopropyl Sulfide as Solvent in Planetary Ball Milling

Li₆PS₅Cl (coarse-LPSCl) and isopropyl sulfide solution were purchased from NEI corporation and Sigma Aldrich, respectively. The LPSCl was ball-milled with isopropyl sulfide solution (1:2 dilution ratio) using a planetary ball-milling machine for 2 hours at 500 rpm, and the milled LPSCl was dried at 80 °C for 8 hours under Argon atmosphere. All samples were handled in a glovebox with oxygen and water levels below 0.1 ppm.

### Example 1.2: Preparing SE Material Using Isopropyl Sulfide as Solvent in Digital Tube Roller Milling

Li₆PS₅Cl (coarse-LPSCl) and isopropyl sulfide solution were purchased from NEI corporation and Sigma Aldrich, respectively. The LPSCl was ball-milled with isopropyl sulfide solution (1:2 dilution ratio) using a digital tube rolling machine for 12 hours at a lower speed mode, and the milled LPSCl was dried at 80 °C for 8 hours under Argon flow.

### Example 1.3: Making All Solid State Batteries

ASSB pellet cells with a diameter of 12 mm, composed of a polyaryletheretherketone (PEEK) mold and Ti rods were assembled. The symmetric cells were fabricated by attaching lithium metal foil with a 100 μm thickness on both sides of the electrolyte pellet. 240 mg of SE pressed under 375 MPa were used as electrolyte. The cathode composite was made by mixing Ni-rich LiNi_{0.8}Co_{0.1}Mn_{0.1}O₂ (NCM811, synthesized in house, ≈1 μm to 5 μm, no coating layer)-the milled LPSCl from Examples 1.1 and 1.2—vapor grown carbon fiber (VGCF, Sigma Aldrich) in a weight ratio of 66:33:1 in a mortar and pestle. The cathode composite loading is around 8 mg/cm². The cathode and electrolyte layers were pressed to 375 MPa, and Li was attached as the anode by being pressed to 30 MPa. Other ASSB pellet cells were made using the same procedures, conditions, and materials, except that LPSCl used in the cathode composites was not milled.

### Example 1.4: Testing All Solid State Batteries

Cell measurements were conducted on a LAND testing system. The galvanostatic charge-discharge tests of all cells were carried out at room temperature (23-25 °C) within the voltage range of 2.5-4.25 V at a rate of 0.1 C at room temperature. FIG. 1A shows the electrochemical performance of a pellet cell with a cathode composite using the LPSCl ball-milled in the presence of isopropyl sulfide using the digital tube roller from Example 1.2 at 0.1 C, 30 °C and 5 MPa. FIG. 1B shows the electrochemical performance of a pellet cell with a cathode composite using the LPSCl that was not milled at 0.1 C, 30 °C and 5 MPa. As shown in FIG. 1A, the cell with the LPSCl ball-milled in the presence of isopropyl sulfide in a digital tube roller exhibits higher capacity than the cell with the LPSC that was not milled in the first cycle. As cycling progressed, the cell with the un-milled LPSCl showed significant capacity degradation of 54.3% capacity retention after 100 cycles. In contrast, the cell with the LPSCl ball-milled in the presence of isopropyl sulfide demonstrated superior cycling stability, retaining 85.6 % capacity. Similarly, a pellet cell with a cathode composite using the LPSCl ball-milled in the presence of isopropyl sulfide from Example 1.1 also showed improved cycling stability compared to a pellet cell with a cathode composite using the un-milled LPSCl.

### EXAMPLE 2: DIMETHYL TRITHIOCARBONATE

### Example 2.1: Preparing SE Material Using Dimethyl Trithiocarbonate as Solvent in Planetary Ball Milling

Li₆PS₅Cl (coarse-LPSCl) and dimethyl trithiocarbonate solution were purchased from NEI corporation and Sigma Aldrich, respectively. The LPSCl was ball-milled with a dimethyl trithiocarbonate solution (1:2 dilution ratio) using a planetary ball-milling machine for 2 hours at 500 rpm, and the milled LPSCl was dried at 80 °C for 8 hours under Argon atmosphere. All samples were handled in a glovebox with oxygen and water levels below 0.1 ppm.

### Example 2.2: Preparing SE Material Using Dimethyl Trithiocarbonate as Solvent in Digital Tube Roller Milling

Li₆PS₅Cl (coarse-LPSCl) and dimethyl trithiocarbonate solution were purchased from NEI corporation and Sigma Aldrich, respectively. The LPSCl was ball-milled with dimethyl trithiocarbonate solution (1:2 dilution ratio) using a digital tube roller machine for 12 hours at a lower speed mode, and the milled LPSCl was dried at 80 °C for 8 hours under Argon flow.

### Example 2.3: Making All Solid State Batteries

ASSB pellet cells with a diameter of 12 mm, composed of a polyaryletheretherketone (PEEK) mold and Ti rods were assembled. The symmetric cells were fabricated by attaching lithium metal foil with a 100 μm thickness on both sides of the electrolyte pellet. 240 mg of SSE pressed under 375 MPa were used as electrolyte. The cathode composite was made by mixing Ni-rich LiNi_{0.8}Co_{0.1}Mn_{0.1}O₂ (NCM811, synthesized in house, synthesized in house, ≈1 μm to 5 μm, no coating layer)—the milled LPSCl from Examples 2.1 and 2.2—vapor grown carbon fiber (VGCF, Sigma Aldrich) in a weight ratio of 66:33:1 in a mortar and pestle. The cathode composite loading is around 8 mg/cm². The cathode and electrolyte layers were pressed to 375 MPa, and Li was attached as the anode by being pressed to 30 MPa. Other ASSB pellet cells were made using the same procedures, conditions, and materials, except that LPSCl used in the cathode composites was not milled.

### Example 2.4: Testing All Solid State Batteries

Cell measurements were conducted on a LAND testing system. The galvanostatic charge-discharge tests of all cells were carried out at room temperature (23-25 °C) within the voltage range of 2.5-4.25 V at a rate of 0.1 C at room temperature. Similar to the cells with cathode composites using the LPSCl ball-milled in the presence of isopropyl sulfide from Examples 1.1 and 1.2, the cells with cathode composites using the LPSCl ball-milled in the presence of dimethyl trithiocarbonate from Examples 2.1 and 2.2 demonstrated superior cycling stability compared to pellet cells with cathode composites using un-milled LPSCl.

### EXAMPLE 3: UNDERCANE

### Example 3.1: Preparing SE Material Using Undercane as Solvent in Planetary Ball Milling

Li₆PS₅Cl (coarse-LPSCl) and undercane solution were purchased from NEI corporation and Sigma Aldrich, respectively. The LPSCl was ball-milled with undercane solution (1:2 dilution ratio) using a planetary ball-milling machine for 2 hours at 500 rpm, and the milled LPSCl was dried at 80 °C for 8 hours under Argon atmosphere. All samples were handled in a glovebox with oxygen and water levels below 0.1 ppm.

### Example 3.2: Preparing SE Material Using Undercane as Solvent in Digital Tube Roller Milling

Li₆PS₅Cl (coarse-LPSCl) and undercane solution were purchased from NEI corporation and Sigma Aldrich, respectively. The LPSCl was ball-milled with undercane solution (1: 2 dilution ratio) using a digital tube roller machine for 12 hours at a lower speed mode, and the milled LPSCl was dried at 80 °C for 8 hours under Argon flow.

### Example 3.3: Making All Solid State Batteries

ASSB pellet cells with a diameter of 12 mm, composed of a polyaryletheretherketone (PEEK) mold and Ti rods were assembled. The symmetric cells were fabricated by attaching lithium metal foil with a 100 μm thickness on both sides of the electrolyte pellet. 240 mg of SSE pressed under 375 MPa were used as electrolyte. The cathode composite was made by mixing Ni-rich LiNi_{0.8}Co_{0.1}Mn_{0.1}O₂ (NCM811, synthesized in house, synthesized in house, ≈1 μm to 5 μm, no coating layer)—the milled LPSCl from Examples 3.1 and 3.2—vapor grown carbon fiber (VGCF, Sigma Aldrich) in a weight ratio of 66:33:1 in a mortar and pestle. The cathode composite loading is around 8 mg/cm². The cathode and electrolyte layers were pressed to 375 MPa, and Li was attached as the anode by being pressed to 30 MPa. Other ASSB pellet cells were made using the same procedures, conditions, and materials, except that LPSCl used in the cathode composites was not milled.

### Example 3.4: Testing All Solid State Batteries

Cell measurements were conducted on a LAND testing system. The galvanostatic charge-discharge tests of all cells were carried out at room temperature (23-25 °C) within the voltage range of 2.5-4.25 V at a rate of 0.1 C at room temperature. Similar to the cells with cathode composites using the LPSCl ball-milled in the presence of isopropyl sulfide from Examples 1.1 and 1.2, the cells with cathode composites using the LPSCl ball-milled in the presence of undercane from Examples 3.1 and 3.2 demonstrated superior cycling stability compared to pellet cells with cathode composites using un-milled LPSCl.

### EXAMPLE 4: HEXADECANE

### Example 4.1: Preparing SE Material Using Hexadecane as Solvent in Planetary Ball Milling

Li₆PS₅Cl (coarse-LPSCl) and hexadecane solution were purchased from NEI corporation and Sigma Aldrich, respectively. The LPSCl was ball-milled with hexadecane solution (1:2 dilution ratio) for 2 hours at 500 rpm using a planetary ball-milling machine, and the milled LPSCl was dried at 80 °C for 8 hours under Argon atmosphere. All samples were handled in a glovebox with oxygen and water levels below 0.1 ppm.

### Example 4.2: Preparing SE Material Using Hexadecane as Solvent in Digital Tube Roller Milling

Li₆PS₅Cl (coarse-LPSCl) and hexadecane solution were purchased from NEI corporation and Sigma Aldrich, respectively. The LPSCl was ball-milled with hexadecane solution (1:2 dilution ratio) using a digital tube roller machine for 12 hours at a lower speed mode, and the milled LPSCl was dried at 80 °C for 8 hours under Argon flow.

### Example 4.3: Making All Solid State Batteries

ASSB pellet cells with a diameter of 12 mm, composed of a polyaryletheretherketone (PEEK) mold and Ti rods were assembled. The symmetric cells were fabricated by attaching lithium metal foil with a 100 μm thickness on both sides of the electrolyte pellet. 240 mg of SSE pressed under 375 MPa were used as electrolyte. The cathode composite was made by mixing Ni-rich LiNi_{0.8}Co_{0.1}Mn_{0.1}O₂ (NCM811, synthesized in house, synthesized in house, ≈1 μm to 5μm, no coating layer)—the milled LPSCl from Examples 4.1 and 4.2—vapor grown carbon fiber (VGCF, Sigma Aldrich) in a weight ratio of 66:33:1 in a mortar and pestle. The cathode composite loading is around 8 mg/cm². The cathode and electrolyte layers were pressed to 375 MPa, and Li was attached as the anode by being pressed to 30 MPa. Other ASSB pellet cells were made using the same procedures, conditions, and materials, except that LPSCl used in the cathode composites was not milled.

### Example 4.4: Testing All Solid State Batteries

Cell measurements were conducted on a LAND testing system. The galvanostatic charge-discharge tests of all cells were carried out at room temperature (23-25 °C) within the voltage range of 2.5-4.25 V at a rate of 0.1C at room temperature. Similar to the cells with cathode composites using the LPSCl ball-milled in the presence of isopropyl sulfide from Examples 1.1 and 1.2, the cells with cathode composites using the LPSCl ball-milled in the presence of hexadecane from Examples 4.1 and 4.2 demonstrated superior cycling stability compared to pellet cells with cathode composites using un-milled LPSCl.

### EXAMPLE 5: OCTANETHIOL

### Example 5.1: Preparing SE Material Using Octanethiol as Solvent in Planetary Ball Milling

Li₆PS₅Cl (coarse-LPSCl) and octanethiol solution were purchased from NEI corporation and Sigma Aldrich, respectively. The LPSCl was ball-milled with octanethiol solution (1:2 dilution ratio) using a planetary ball-milling machine for 2 hours at 500 rpm, and the milled LPSCl was dried at 80 °C for 8 hours under Argon atmosphere. All samples were handled in a glovebox with oxygen and water levels below 0.1 ppm.

### Example 5.2: Preparing SE Material Using Octanethiol as Solvent in Digital Tube Roller Milling

Li₆PS₅Cl (coarse-LPSCl) and dimethyl trithiocarbonate solution were purchased from NEI corporation and Sigma Aldrich, respectively. The LPSCl was ball-milled with octanethiol solution (1:2 dilution ratio) using a digital tube roller machine for 12 hours at a lower speed mode, and the milled LPSCl was dried at 80 °C for 8 hours under Argon flow.

### Example 5.3: Making All Solid State Batteries

ASSB pellet cells with a diameter of 12 mm, composed of a polyaryletheretherketone (PEEK) mold and Ti rods were assembled. The symmetric cells were fabricated by attaching lithium metal foil with a 100 μm thickness on both sides of the electrolyte pellet. 240 mg of SSE pressed under 375 MPa were used as electrolyte. The cathode composite was made by mixing Ni-rich LiNi_{0.8}Co_{0.1}Mn_{0.1}O₂ (NCM811, synthesized in house, synthesized in house, ≈1 μm to 5 μm, no coating layer)—the milled LPSCl from Examples 5.1 and 5.2—vapor grown carbon fiber (VGCF, Sigma Aldrich) in a weight ratio of 66:33:1 in a mortar and pestle. The cathode composite loading is around 8 mg/cm². The cathode and electrolyte layers were pressed to 375 MPa, and Li was attached as the anode by being pressed to 30 MPa. Other ASSB pellet cells were made using the same procedures, conditions, and materials, except that LPSCl used in the cathode composites was not milled.

### Example 5.4: Testing All Solid State Battery

Cell measurements were conducted on a LAND testing system. The galvanostatic charge-discharge tests of all cells were carried out at room temperature (23-25 °C) within the voltage range of 2.5-4.25 V at a rate of 0.1 C at room temperature. Similar to the cells with cathode composites using the LPSCl ball-milled in the presence of isopropyl sulfide from Examples 1.1 and 1.2, the cells with cathode composites using the LPSCl ball-milled in the presence of octanethiol from Examples 5.1 and 5.2 demonstrated superior cycling stability compared to pellet cells with cathode composites using un-milled LPSCl.

### EXAMPLE 6: UNDECANETHIOL

### Example 6.1: Preparing SE Material Using Undecanethiol as Solvent in Planetary Ball Milling

Li₆PS₅Cl (coarse-LPSC) and undecanethiol solution were purchased from NEI corporation and Sigma Aldrich, respectively. The LPSC was ball-milled with undecanethiol solution (1:2 dilution ratio) using a planetary ball-milling machine for 2 hours at 500 rpm, and the milled LPSCl was dried at 80 °C for 8 hours under Argon atmosphere. All samples were handled in a glovebox with oxygen and water levels below 0.1 ppm.

### Example 6.2: Preparing SE Material Using Undecanethiol as Solvent in Digital Tube Roller Milling

Li₆PS₅Cl (coarse-LPSCl) and undecanethiol solution were purchased from NEI corporation and Sigma Aldrich, respectively. The LPSCl was ball-milled with undecanethiol solution (1:2 dilution ratio) using a digital tube roller machine for 12 hours at a lower speed mode, then the milled LPSCl was dried at 80 °C for 8 hours under Argon flow.

### Example 6.3: Making All Solid State Batteries

ASSB pellet cells with a diameter of 12 mm, composed of a polyaryletheretherketone (PEEK) mold and Ti rods were assembled. The symmetric cells were fabricated by attaching lithium metal foil with a 100 μm thickness on both sides of the electrolyte pellet. 240 mg of SSE pressed under 375MPa were used as electrolyte. The cathode composite was made by mixing Ni-rich LiNi_{0.8}Co_{0.1}Mn_{0.1}O₂ (NCM811, synthesized in house, synthesized in house, ≈1 μm to 5 μm, no coating layer)-the milled LPSCl from Examples 6.1 and 6.2 −vapor grown carbon fiber (VGCF, Sigma Aldrich) in a weight ratio of 66:33:1 in a mortar and pestle. The cathode composite loading is around 8 mg/cm². The cathode and electrolyte layers were pressed to 375 MPa, and Li was attached as the anode by being pressed to 30 MPa. Other ASSB pellet cells were made using the same procedures, conditions, and materials, except that LPSCl used in the cathode composites was not milled.

### Example 6.3: Testing All Solid State Battery

Cell measurements were conducted on a LAND testing system. The galvanostatic charge-discharge tests of all cells were carried out at room temperature (23-25 °C) within the voltage range of 2.5-4.25 V at a rate of 0.1 C at room temperature. Similar to the cells with cathode composites using the LPSCl ball-milled in the presence of isopropyl sulfide from Examples 1.1 and 1.2, the cells with cathode composites using the LPSCl ball-milled in the presence of undecanethiol from Examples 6.1 and 6.2 demonstrated superior cycling stability compared to pellet cells with cathode composites using un-milled LPSCl.

### EXAMPLE 7: HEXADECANETHIOL

### Example 7.1: Preparing SE Material Using Hexadecanethiol as Solvent in Planetary Ball Milling

Li₆PS₅Cl (coarse-LPSCl) and hexadecanethiol solution were purchased from NEI corporation and Sigma Aldrich, respectively. The LPSCl was ball-milled with hexadecanethiol solution (1:2 dilution ratio) using a planetary ball-milling machine for 2 hours at 500 rpm, and the milled LPSCl was dried at 80 °C for 8 hours under Argon atmosphere. All samples were handled in a glovebox with oxygen and water levels below 0.1 ppm.

### Example 7.2: Preparing SE Material Using Hexadecanethiol as Solvent in Digital Tube Roller Milling

Li₆PS₅Cl (coarse-LPSC) and hexadecanethiol solution were purchased from NEI corporation and Sigma Aldrich, respectively. The LPSCl was ball-milled with hexadecanethiol solution (1:2 dilution ratio) using a digital tube roller machine for 12 hours at a lower speed mode, and the milled LPSCl was dried at 80 °C for 8 hours under Argon flow.

### Example 7.3: Making All Solid State Batteries

ASSB pellet cells with a diameter of 12 mm, composed of a polyaryletheretherketone (PEEK) mold and Ti rods were assembled. The symmetric cells were fabricated by attaching lithium metal foil with a 100 μm thickness on both sides of the electrolyte pellet. 240 mg of SSE pressed under 375 MPa were used as electrolyte. The cathode composite was made by mixing Ni-rich LiNi_{0.8}Co_{0.1}Mn_{0.1}O₂ (NCM811, synthesized in house, synthesized in house, ≈1 μm to 5 μm, no coating layer)-the milled LPSCl from Examples 7.1 and 7.2 −vapor grown carbon fiber (VGCF, Sigma Aldrich) in a weight ratio of 66:33:1 in a mortar and pestle. The cathode composite loading is around 8 mg/cm². The cathode and electrolyte layers were pressed to 375 MPa, and Li was attached as the anode by being pressed to 30 MPa. Other ASSB pellet cells were made using the same procedures, conditions, and materials, except that LPSCl used in the cathode composites was not milled.

### Example 7.6: Testing All Solid State Batteries

Cell measurements were conducted on a LAND testing system. The galvanostatic charge-discharge tests of all cells were carried out at room temperature (23-25 °C) within the voltage range of 2.5-4.25 V at a rate of 0.1 C at room temperature. Similar to the cells with cathode composites using the LPSCl ball-milled in the presence of isopropyl sulfide from Examples 1.1 and 1.2, the cells with cathode composites using the LPSCl ball-milled in the presence of hexadecanethiol from Examples 7.1 and 7.2 demonstrated superior cycling stability compared to pellet cells with cathode composites using un-milled LPSCl.

### Combinations and Characteristics Included

Various features and characteristics are described in this specification to provide an understanding of the composition, structure, production, function, and/or operation of the present disclosure, which includes the disclosed compositions, coatings, and methods. It is understood that the various features and characteristics of the present disclosure described in this specification can be combined in any suitable manner, regardless of whether such features and characteristics are expressly described in combination in this specification. The Inventors and the Applicant expressly intend such combinations of features and characteristics to be included within the scope of the present disclosure described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

### Incorporated by Reference

Any patent, publication, or other document identified in this specification is incorporated by reference into this specification in its entirety unless otherwise indicated but only to the extent that the incorporated material does not conflict with existing descriptions, definitions, statements, illustrations, or other disclosure material expressly set forth in this specification. As such, and to the extent necessary, the express disclosure as set forth in this specification supersedes any conflicting material incorporated by reference. Any material, or portion thereof, that is incorporated by reference into this specification but that conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference. The amendment of this specification to add such incorporated subject matter will comply with the written description, sufficiency of description, and added matter requirements.

### Illustration of Various Aspects

While the present disclosure provides descriptions of various specific aspects for the purpose of illustrating various aspects of the present disclosure and/or its potential applications, it is understood that variations and modifications will occur to those skilled in the art. Accordingly, the present disclosure herein should be understood to be at least as broad as claimed and not as more narrowly defined by particular illustrative aspects provided herein.

What is claimed is:

1. A method of preparing a solid electrolyte (SE) material, the method comprising:
providing SE material particles, a solvent, and milling balls such that the SE material particles and the milling balls are completely submerged in the solvent,
wherein the SE particles comprise a sulfide-containing material,
wherein the solvent is selected from the group consisting of isopropyl sulfide, dimethyl trithiocarbonate, undercane, hexadecane, octanethiol, undecanethiol, hexadecanethiol, and mixtures thereof,
performing ball milling of the SE material particles such that at least part of the SE material particles break down into smaller particles referred to as “milled particles,”
wherein while performing the ball milling, the SE material particles and the milled particles are completely submerged in the solvent; and
separating milled SE material particles from the solvent; and
drying the milled SE material particles.

2. The method of claim 1, wherein the solvent is selected from the group consisting of octanethiol, undecanethiol, hexadecanethiol, and mixtures thereof, wherein a thiol group of the solvent interacts with sulfur of the sulfide-containing material of the SE material particles on surfaces thereof, and further such that a hydrophobic hydrocarbon tail of the solvent is oriented outward from the surfaces of the SE material particles and forms a lipid barrier on the surfaces.

3. The method of claim 1, wherein the solvent and the SE material particles have a weight ratio from about 0.4:1 to about 10:1.

4. The method of claim 1, wherein the solvent and the SE material particles have a weight ratio of about 5:1.

5. The method of claim 1, wherein the milling balls and the SE material particles have a weight ratio from about 10:1 to about 25:1.

6. The method of claim 1, wherein the milling balls and the SE material particles have a weight ratio from about 20:1.

7. The method of claim 1, wherein the SE material particles have a weight from about 100 mg to about 500 mg.

8. The method of claim 1, wherein the solvent has a weight from about 200 mg to about 1000 mg.

9. The method of claim 1, wherein the milling balls have a weight from about 200 mg to about 12500 mg.

10. The method of claim 1, wherein the milling balls have a diameter from about 1.5 mm to about 3 mm.

11. The method of claim 1, wherein the milling balls have a diameter of 1.5 mm.

12. The method of claim 1, wherein the ball milling is performed at about 300 to about 700 RPM for about 1 to about 2 hours.

13. The method of claim 1, wherein the ball milling is performed at about 500 RPM for about 2 hours.

14. The method of claim 1, wherein the ball milling is performed at about 20 to about 60 RPM for about 10 to about 15 hours.

15. The method of claim 1, wherein the ball milling is performed at about 20 RPM for about 12 hours.

16. The method of claim 8, wherein the SE material particles have particle sizes in a range of about 1 μm to about 50 μm.

17. The method of claim 1, wherein the milled particles have particle sizes in a range of about 500 nm to about 25 μm.

18. The method of claim 1, wherein the SE material particles comprise halogenated lithium phosphorous sulfide (LPS-X) particles, wherein X is selected from the group consisting of Cl, Br, I, and combinations thereof.

19. The method of claim 18, wherein the LPS-X particles comprise LPSCl.

20. A method of making an all-solid-state lithium battery, the method comprising:
providing a cathode;
providing a solid electrolyte layer comprising a solid electrolyte prepared by the method of claim 1; and
providing an anode such that the solid electrolyte layer is interposed between the cathode and the anode.
